(19) United States
(12) Patent Application Publication
(10) Pub. No.: US 2008/0134088 A1
(43) Pub. Date: Jun. 5, 2008

(54) Device for saving results of location based searches

(75) Inventors: Ed Tse, Stanford, CA (US); Sachin S. Kansal, Sunnyvale, CA (US); William Kam Stewart, San Francisco, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 11/731,750

(22) Filed: Mar. 30, 2007

Related U.S. Application Data
(63) Continuation-in-part of application No. 11/634,328, filed on Dec. 5, 2006.
Application No. 11/634,328 is a continuation-in-part of application No. 11/634,365, filed on Dec. 5, 2006.

(51) Int. Cl. G06F 3/048; G06F 17/30

(52) U.S. Cl. 715/810; 707/3; 707/E17.005

(57) ABSTRACT

Results of a Location Based Search can be saved for later use. The results can be saved as a contact in a contacts application. The device may automatically populate various fields of a contact based on a request by a user to save the search result as a contact. Once saved as a contact, the location based search result contact may be used to place a phone call, send an e-mail, access a website, review a menu, or take some other action.

### CROSS-REFERENCE TO RELATED PATENT APPLICATIONS

This application is a continuation-in-part of U.S. application Ser. No. 11/634,328, filed Dec. 5, 2006, entitled “SYSTEM AND METHOD FOR PROVIDING ADDRESS-RELATED LOCATION-BASED DATA,” and is a continuation-in-part of U.S. application Ser. No. 11/634,365, filed Dec. 5, 2006, entitled “DEVICE FOR PROVIDING LOCATION-BASED DATA.” The disclosures of each of these applications is herein incorporated by reference in their entirety.

### BACKGROUND

The present invention relates generally to the field of location-based services, and more particularly, to providing location-based services via a main image of a mobile computing device.

Typical location-based services provided on electronic devices such as desktop or laptop computers may provide, for example, mapping capabilities that enable a user to enter a starting point (e.g., a starting street address, city, and/or state/zip code) and a destination point (e.g., a destination street address, city, and/or state/zip code), and receive as output from the electronic device textual or graphical directions from the starting point to the destination point, point of interest information, etc. These services, however, typically cannot determine the location of the electronic device (which often may be the starting point) and the user must manually enter the information.

Other types of location-based services, often provided on mobile electronic devices, may take the location of the user into account through the use of, for example, a Global Positioning System or other location-determining system. Consequently, a user wishing to obtain location-based information is able to base directions, point of interest information, etc., on his or her current location, without having to manually enter a starting point location, and must therefore enter only a destination point location. However, these services are typically not provided as part of the primary or main image or display of the mobile device, and may require a user to scroll through several images of information or upload an application prior to being able to enter the desired location information.

Accordingly, there is a need for an electronic device that is able to provide location-based services where the electronic device is able to determine the current location of the device. Further, there is a need for an electronic device that provides location-based services on the main image of the device.

The teachings herein extend to those embodiments which are within the scope of the appended claims, regardless of whether they accomplish one or more of the above-identified needs.

### BRIEF DESCRIPTION OF THE FIGURES

FIG. 1 is a front view of a mobile computing device according to an exemplary embodiment;

FIG. 2 is a back view of the mobile computing device of FIG. 1;

FIG. 3 is a block diagram of the mobile computing device of FIG. 1 according to an exemplary embodiment;

FIG. 4 is an illustration of a main image of the mobile computing device of FIG. 1 according to an exemplary embodiment;

FIG. 5 is a series of location-based search fields that may be used in conjunction with the main image of FIG. 4;

FIG. 6 is an illustration of a results image for a location-based search according to an exemplary embodiment;

FIG. 7 is an illustration of the results image of FIG. 6 including a menu of options for a selected result according to an exemplary embodiment;

FIG. 8 is an illustration of an image showing to/from information for a selected result according to an exemplary embodiment;

FIG. 9 is an illustration of a results image for a location-based search according to an exemplary embodiment;

FIG. 10 is an illustration of the results image of FIG. 9 including information for a selected result;

FIG. 11 is an illustration of the results image of FIG. 10 including a menu of options for the selected result;

FIG. 12 is an illustration of an image showing to/from information for a selected result according to an exemplary embodiment;

FIG. 13 is an illustration of a results image for a location-based search for a specific destination according to an exemplary embodiment;

FIG. 14 is a flowchart illustrating the process of conducting a location-based search from the main image of a mobile computing device according to an exemplary embodiment;

FIG. 15 is an image of information from a contacts database according to an exemplary embodiment;

FIG. 16 is an image of an email according to an exemplary embodiment;

FIG. 17 is an image of an email according to another exemplary embodiment;

FIG. 18 is an image for a location-based data application according to an exemplary embodiment;

FIG. 19 is a flowchart illustrating the process of providing location-based data according to an exemplary embodiment;

FIG. 20 is a flowchart showing the process of providing location-based data according to another exemplary embodiment;

FIGS. 21A-D are illustrations of fields that can be edited for an exemplary contacts application;

FIG. 22 is a list view of contacts from an exemplary contacts application;

FIG. 23 is a block diagram of some portions of a system and apparatus according to some embodiments such as the embodiment of FIG. 1;

FIG. 24 is a functional diagram according to one embodiment, which may be used with the system of FIG. 23; and

FIGS. 25A-F are diagrams of a smartphone according to one exemplary embodiment of the device described in FIG. 23.

### DETAILED DESCRIPTION OF EXEMPLARY EMBODIMENTS

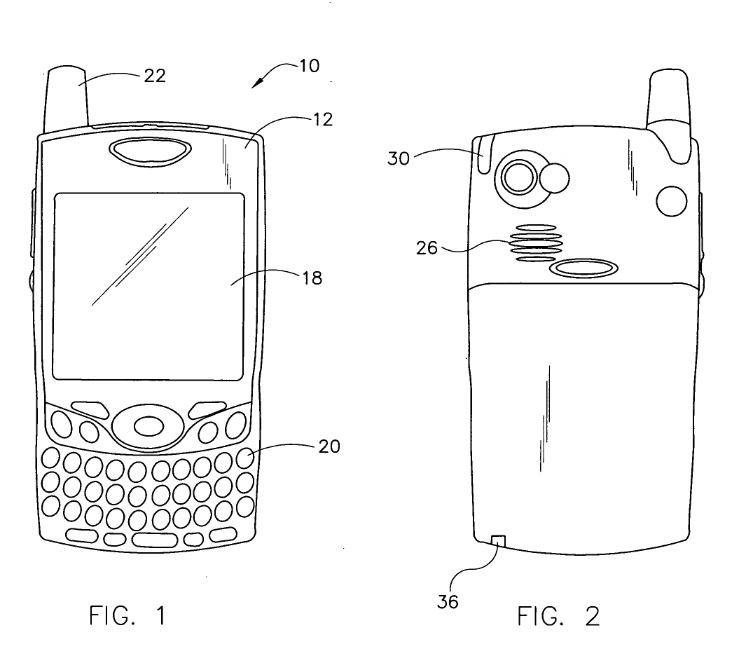

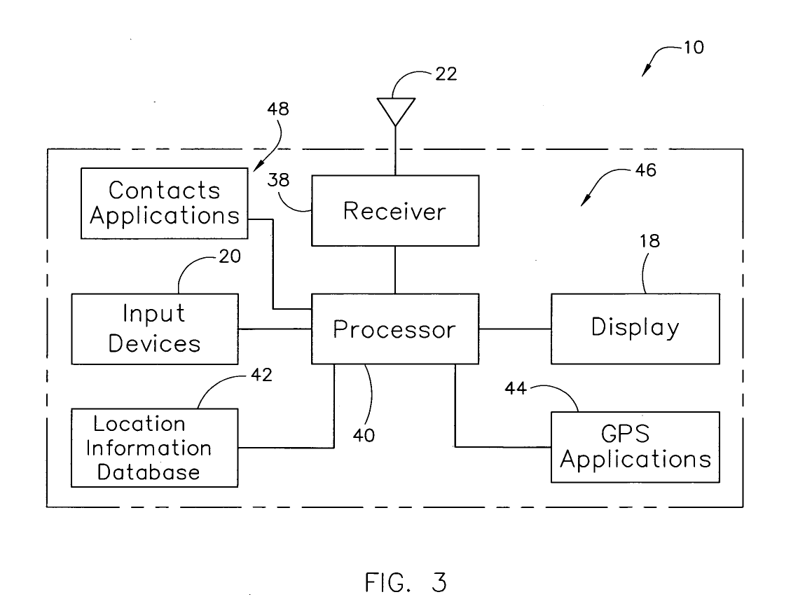

Referring to FIGS. 1 and 3, an electronic device 10 includes a processor 40. Device 10 may be a mobile computing device such as a Smartphone (or other type of phone) that includes a receiver 38 configured to enable wireless communication using antenna 22.

Device 10 may further comprise a location information database 42. Database 42 may include information for various locations (e.g., streets, intersections, restaurants, hotels, banks, etc.), including location names, addresses, phone numbers, etc., and may contain additional location-specific information (e.g., hours of operation, menus, point-of-interest information, etc.). This information may be updated (e.g. periodically, any time there is a change in the information, etc.). Information for every POI may be updated, or only some of the POI's may have their information updated. According to some embodiments, a POI that a user marks as special may have its information updated more frequently than information for a POI not marked as special (e.g. a POI marked as special may have its information updated regularly while a POI not marked as special may not have its information updated). A POI may be marked as special by saving it, such as in a contacts application.

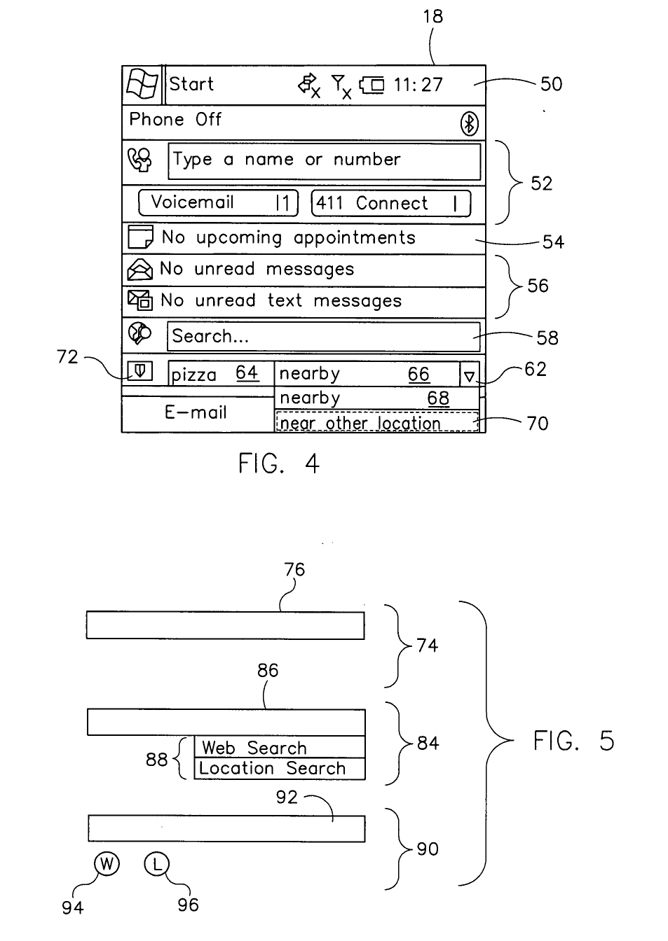

As discussed in more detail below, processor 40 (e.g., operating a location data application) may be configured to access the information stored in database 42 and, in response to a location-based search, provide information regarding locations that may be located at a specific address, near the current location of device 10, near a different location (e.g., city, state, zip code, etc.), etc. Various embodiments of initiating a location-based search from a main image of an electronic device will now be discussed in more detail with particular reference to FIGS. 4 and 5.

### Initiating a Location Based Search from a Main Image

Referring to FIG. 4, according to some embodiments, processor 40 can provide various images via display 18, such as main image 50 shown in FIG. 4. Image 50 is one of numerous images, displays, screens, pages, etc. that processor 40 provides via display 18. Other images may include additional e-mail information, calendar information, contacts information, web-browsing information, etc.

Main image 50 may include various types of information fields and input interfaces (e.g., icons on the touch screen that function as input buttons when touched by or clicked on by a user such as by using stylus 30). According to some embodiments, image 50 may include a plurality of image portions, each of which is associated with an application that is capable of storing personalized user data (e.g., phone numbers, calendar appointments, email or other messages, contact information, etc.). For example, image 50 may include a phone image portion 52, which may include phone information and a user input field to receive a phone number and/or a name to look up in a contacts database, a voicemail icon, and an information (e.g., “411”) icon. Image 50 may include a calendar image portion 54, which may include calendar information and indicate whether a user has any upcoming appointments, and/or other calendar information. Further, image 50 may include a message image portion 56, which may provide messaging information and/or indications as to whether any new email, text messages, and/or other types of messages have recently been received or remain unread. Image 50 may include web search image portion 58 that may include a user input field and permits users to enter search queries such as for traditional web-based searches. Image 50 may include a location based search (LBS) image portion 62 for receiving a request for location-based data.

According to some embodiments, image 50 includes more than one (e.g. multiple and/or each) of image portions 52-62 displayed simultaneously. All such combinations of one, two, three, four, and five of these images portions being displayed simultaneously are separately contemplated.

Each of image portions 52-62 may be associated with a particular application (e.g., email, calendar, phone, etc.) and may provide a subset of the data (e.g., personalized user data) that would be displayed should a user select the application for use (e.g., by tapping on the appropriate image portion for the desired application). One or more of image portions 52-62 may be associated with a common application or applications as another of image portions 52-62. Each of image portions 52-62 may include user input features such as selectable icons or user input fields (e.g., a text box, etc.), and the image portions 52-62 themselves may be selectable to launch or otherwise invoke a respective application. Each of image portions 52-62 may include textual representations or descriptions of the applications, or actual textual or other data stored by the application (e.g., the text of an email, text message, etc.).

According to some embodiments, image 50 may be reconfigurable by a user such that a user may select which applications are represented by the various image portions 52-62, modify the order and/or manner in which the image portions 52-62 are displayed, and/or select which image portions 52-62 are displayed.

According to some embodiments, image 50 is the default image that appears upon starting device 10 (e.g. powering-up device 10, logging on to device 10, etc.). According to some embodiments, image 50 may be embedded within one or more other images, screens, pages, etc. of device 10, but include a plurality of image portions each providing a subset of data (e.g., personalized user data) for a particular application (e.g., email, calendar, phone, etc.). According to some embodiments, image 50 may be the “top level” image provided to users as users “back out” of previous images, for example, by pressing an “ok” or “back” key one or more times from other images provided on device 10. According to some embodiments, image 50 may be provided as a menu, such as a drop-down menu, that is accessible from one or more other images, and may include a user input field for receiving a request for location-based data.

Image portion 62 may include user input fields 64 and 66 (search bars, text boxes, etc.), which in some embodiments are search text boxes configured to receive inputs from a user of device 10, either via input device 20, touch screen display 18, and/or other input. User input fields 64, 66 receive search requests, search query parameters, and/or other search related information that are used to perform a location-based search. According to some embodiments, user input field 64 receives a description of what (e.g., a type of or a name of a destination) a user wants to locate (e.g., a restaurant, a bank, an automated teller machine (ATM), etc.) and user input field 66 receives location information related to the destination (e.g., near the current location of device 10, at or near a specific address, within or near a specific geographic division—such as zip code, city, state, and/or other geographic division—and/or near some other location).

For example, a user may want to locate a pizza restaurant near the user's current location. As shown in FIG. 4, the user may enter the term “pizza” into user input field 64. The user may then select (e.g., right-arrow to, click-on, touch via a touch screen, etc.) user input field 66, upon which device 10 displays a menu (e.g., pull down menu) having options 68, 70. Options 68, 70 may include directions that instruct device 10 to locate destinations for the term “pizza” that are near the user's current location (option 68), near a different location (option 70), within a specific area, etc. The user selects the desired option, and if necessary, may be prompted to enter further information into user input field 66 (e.g., if a user selects option 70 “near another location”—the user may then be prompted to enter the other location, such as a city name). Alternatively, rather than selecting a menu option, the user may manually type the desired information into user input field 66. According to some embodiments, to search for a particular street address, a user may enter the street address into user input field 64, and enter the city, state, zip code, etc. (if known) into user input field 66. Upon completion of entering the required information into user input fields 64 and 66, the user initiates the location-based search. Initiation of the location-based search may be done in a variety of ways, including selecting a designated icon 72 on display 18, depressing a designated input button on input device 20, etc.

It should be noted that as shown in FIG. 4 both of user input fields 64, 66 are populated. According to some embodiments, processor 40 recognizes when one of user input fields 64, 66 is not populated and, if necessary, uses default values for the missing information. For example, should a user enter “pizza” into user input field 64 and initiate a location-based search without specifying any search criteria in user input field 66, processor 40 may use the “nearby” option (option 68) as a default. Alternatively, if a user wishes to locate a specific street address, the user may enter only the street address into user input field 64 and no information into user input field 66. As a default, processor 40 may then list any matches to the street address in order of proximity to the current location of device 10. The default settings may vary, and device 10 may further permit users to configure the default settings.

Image portion 62 may include two separate user input fields 64, 66. According to various alternative embodiments, other types of user input fields may be provided as a part of image portion 62 and main image 50 to enable a user to input the location-based search information.

Referring to FIG. 5, exemplary variations on a location data image portion include, according to some embodiments, an image portion 74 having a single user input field 76 that replaces user input fields 64 and 66. A user enters a search request into user input field 76, and the location-based search is then initiated. Processor 40 may be configured to recognize search strings that include connectors such as “at,” “near,” “in,” etc., such that users can enter essentially the same information into user input field 76 as they can into both user input fields 64, 66 (e.g., instead of entering “pizza” into user input field 64 and “Chicago” into user input field 66, a user may enter “pizza in Chicago” into user input field 76). In some embodiments, the connector may be implied based on the information. For example, processor 40 may identify POI-type terms (pizza, museum, restaurant, gas, etc.) as the subject of the search and location-type terms as the location input of the search (e.g. a geographic reference, a contact's address, etc.). An absence of a location-type term may imply nearest. When receiving a search without a connector, processor 40 may be configured to imply that the connector is a common connector such as “at” or “near.”

According to some embodiments, an image portion 84 may include a single user input field 86 that serves as user input fields 64, 66, and as a traditional web-based user input field (e.g. the user input field illustrated as part of image portion 58 in FIG. 4). User input field 86 operates similarly to user input field 76, except user input field 86 is an integrated user input field for both traditional web-based searching (e.g., via Google or other web search service), and location-based searching. Upon entering the search request search query into user input field 86, the user may activate a menu such as pull-down menu 88, from which the user may choose to either perform a traditional web-based search or a location-based search.

According to some embodiments, an image portion 90 may include a user input field 92 that operates similarly to user input field 86, in that user input field 92 is an integrated web-based/location-based user input field. However, rather than utilizing a menu to specify the search type, user input field 92 is accompanied by two icons 94, 96 displayed adjacent to user input field 92. Icon 94 initiates a traditional web-based search, and icon 96 initiates a location-based search. Icons 94, 96 may be selected via input device 20, via display 18, and/or through any other suitable input device. While icons 94, 96 are illustrated in FIG. 5 as being positioned below user input field 92, according to various alternative embodiments, icons 94, 96 may be located at other locations on display 18 (e.g., in a side-by-side orientation next to user input field 92).

It should be noted that minimizing the number of user input fields displayed on the main image of an electronic device (e.g., by integrating a web-based user input field and a location-based user input field) may permit the maximization of the use of the available display space, or “real estate,” available on device displays, particularly with respect to mobile electronic devices such as PDA's, smartphones, etc., where mobility requirements might constrain the space available for displaying images.

Once the search query or request is entered and the location-based search is initiated, processor 40 communicates with a location application (e.g. GPS application 44, a cell-based application, and/or other location-determining application), which may include one or more of an “on-board” (integral with device 10) system, a system that is nearby and communicating with device 10 (e.g. over a personal area network such as over Bluetooth, infrared, etc.), and a system that is distant from device 10 (e.g. a cell-based system relying on a remote server) to determine the current geographic location of device 10.

Processor 40 may utilize the current location of device 10 and the search query received from the user to search location information database 42 for matching search results. According to some embodiments, if the location application (e.g. GPS application 44) is unable to determine the current location of device 10, processor 40 may prompt a user to manually input the current location, or may display a list of default locations (e.g., home address, recently visited locations, work address, etc.) from which a default location may be chosen. The search results include location-based data, which may comprise directions Processor 40 may perform the location-based search in conjunction with location information database 42, both of which, as shown in FIG. 3, can be located on device 10 (i.e., a fully “on-board” configuration).

According to an alternative embodiment, processor 40 may wirelessly transmit the location of device 10 and the search query information received via search field 64 to a remote (e.g., physically detached) server that performs the location-based search and wirelessly transmits the results back to device 10 (i.e., an “off-board” configuration). According to some embodiments, database 42 is located on the remote server rather than as a part of device 10. An off-board configuration may provide more accurate results than an on-board configuration because the location information database maybe updated more regularly. However, off-board configurations may require additional time to return results because of the additional transmissions involved.

According to another alternative embodiment, processor 40 performs the location-based search in conjunction with location information database 42, both of which are a part of device 10, as in the on-board configuration discussed above, but in addition, processor 40 may periodically (e.g., at set intervals, at intervals based on the location of device 10, etc.) communicate wirelessly with a remote server, as in the off-board configuration discussed above, to update the information stored in location information database 42 (e.g., in a “hybrid” version of an on-board configuration), and identify any updates in information (e.g., new locations, etc.) that have been stored on the remote server or other device since the last update of location information database 42.

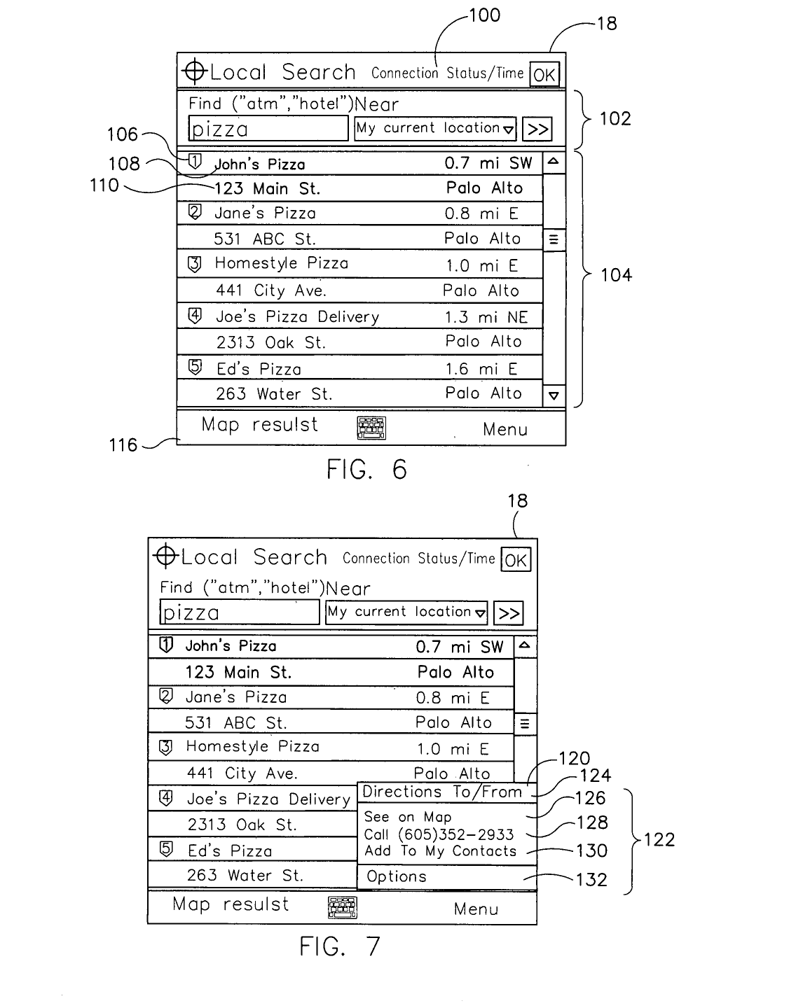

Once the results of the location-based search are generated, the results may be displayed on display 18. Various embodiments of images that may be used to provide the results of a location-based search are discussed in more detail below with respect to FIGS. 6-13.

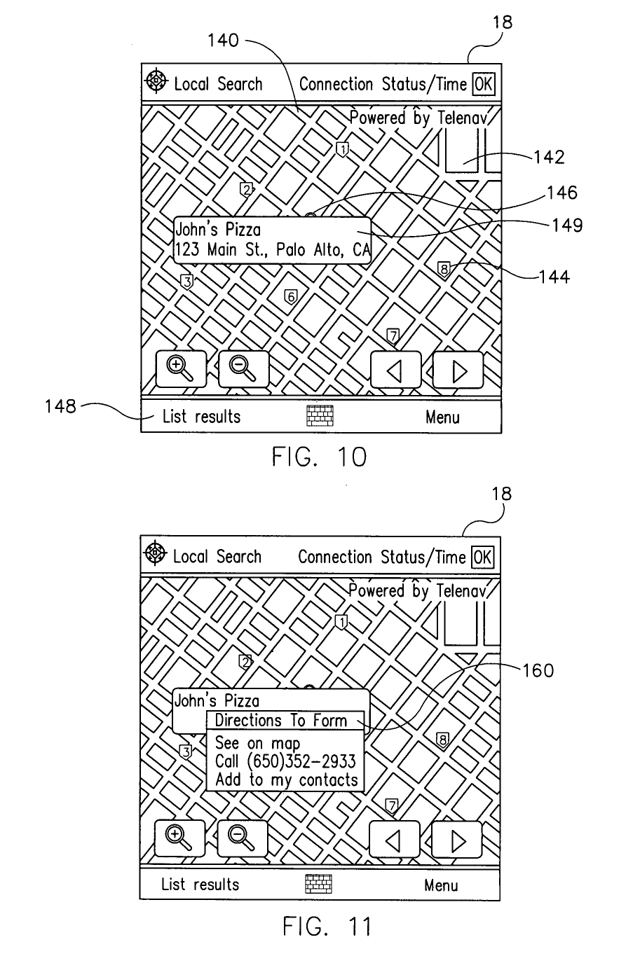

Referring now to FIG. 6, display 18 showing an image 100 of location-based search results is illustrated. The search results may be displayed either textually (e.g., in a list format) as shown in FIG. 6, or graphically (e.g., superimposed upon a map) as shown in FIGS. 9 and 10. As shown in FIG. 6, an image 100 provided on display 18 may identify the search parameters 102 used and the search results 104 generated. Each search result 104 may include information such as an item number 106, a destination name 108, a destination address 110 (if available), a distance and/or direction 112 to the destination (e.g., from the current location of device 10 or another specified location), and other location information 114 (e.g., a city, state, zip code, etc.). A user may scroll through the results using input device 20, display 18, etc., and/or select a desired destination. As shown in FIG. 6, a user has highlighted destination item number 1 (“John's Pizza”).

Referring further to FIG. 6, search results 104 are provided as a textual list. FIG. 6 may include a toggle button 116 that permits a user to toggle between a textual list as shown in FIG. 6 and a graphical image of results, as shown in FIGS. 9 and 10. According to some embodiments, shown in FIGS. 9 and 10, the location-based search results may be provided as a graphical display utilizing a geographic map having street names, point of interest identifiers, etc. For example, as shown in FIGS. 9 and 10, an image 140 may include a map 142 that contains item numbers or results 144 located on map 142 corresponding to the location-based search results. Image 140 may also include the current location 146 of device 10 and a toggle button 148 that permits a user to toggle back to the textual list (such as image 100 shown in FIG. 6) of results. As shown in FIG. 10, detailed information 149 may be provided for an individual result by a user selecting (e.g., hovering over, clicking on, etc.) a specific result 144 on image 140.

Referring now to FIG. 7, according to some embodiments, upon selecting an individual search result (e.g., from an image such as image 100 shown in FIG. 6), a user is displayed a menu 120 that provides one or more options 124-132 that may be selected. As shown in FIG. 7, menu 120 is a drop down menu that may be scrolled through, and may include options such as “Directions To/From” 124, “See on Map” 126, “Call [phone number]” 128, “Add to my contacts” 130, and/or “Options” 132. More or fewer options may be provided as a part of menu 120, and menu 120 may be provided in a variety of formats and configurations. Menu 120 may be displayed over a textual list of results as shown in FIG. 7, or optionally, as shown in FIG. 11 a menu 160 may be displayed over a graphical map of results, with the same options being available. According to some embodiments, menu 120 may be displayed as a separate image on display 18.

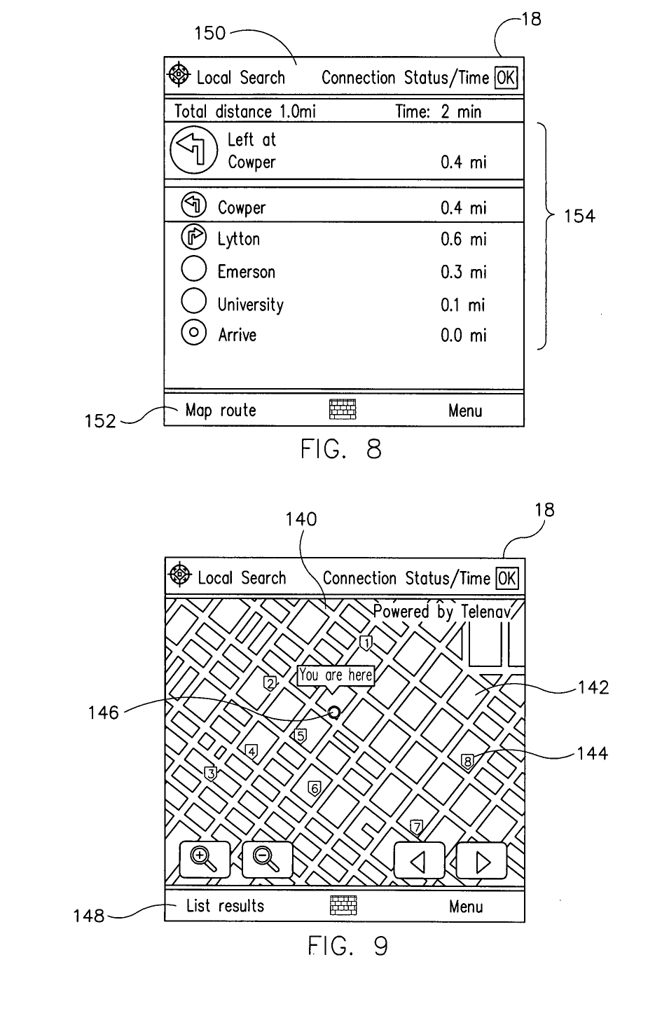

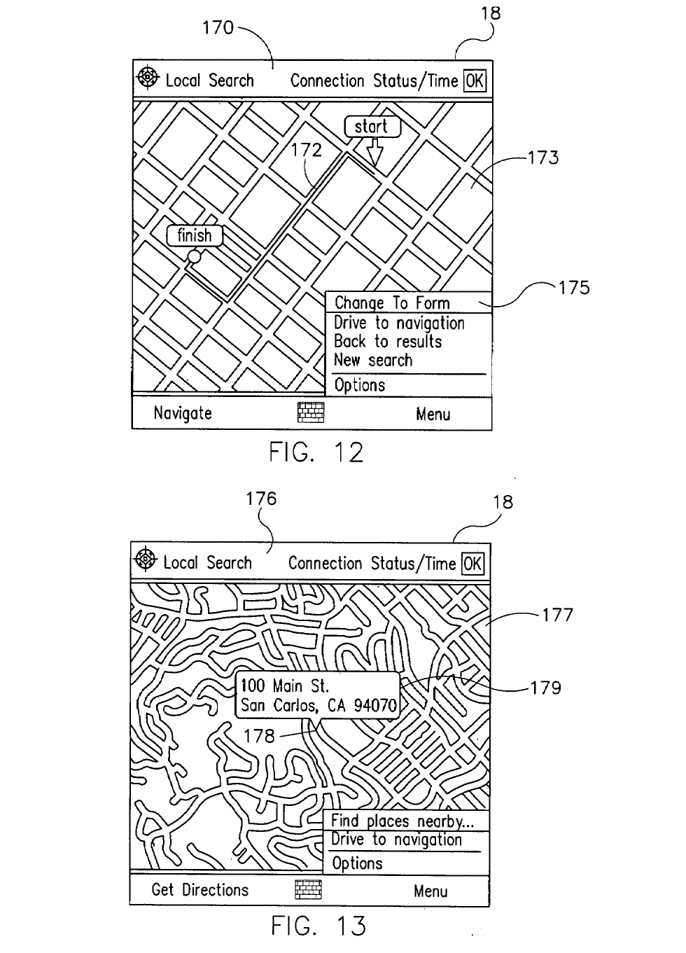

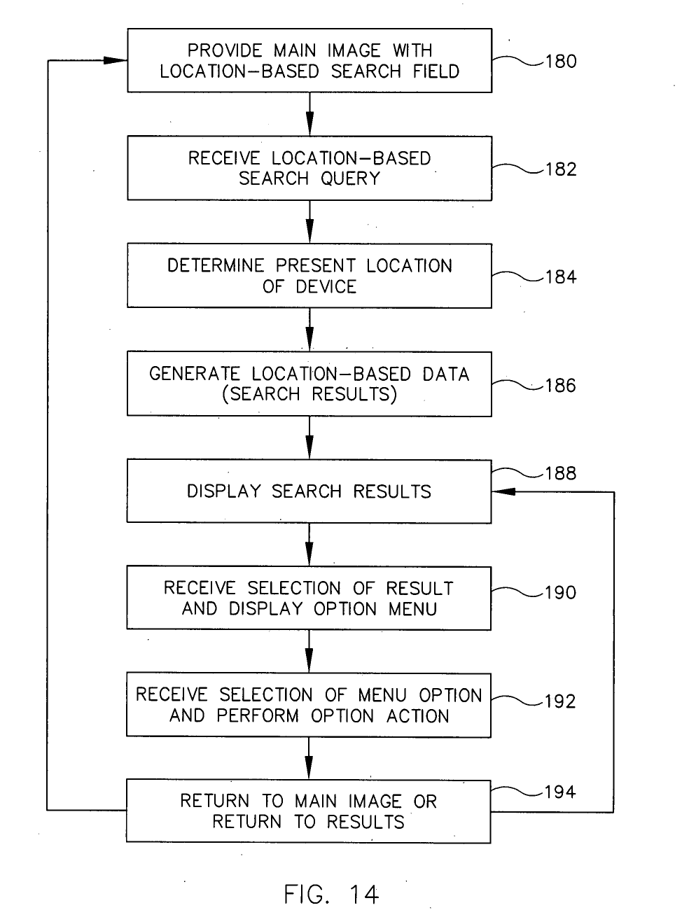

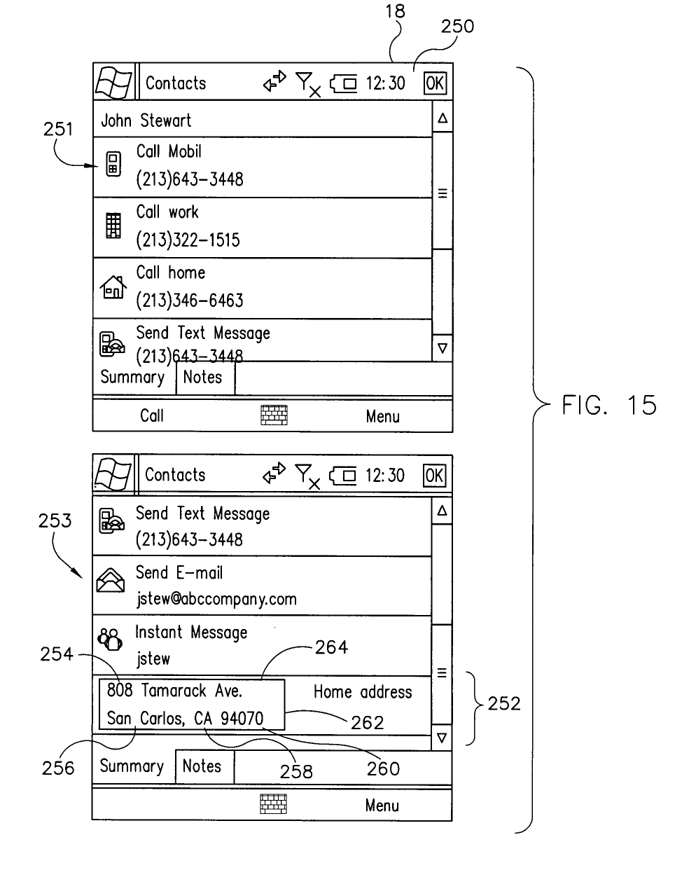

Upon one of options 124-132 of FIG. 7 being selected, processor 40 performs the appropriate action. For example, upon option 124 being selected, processor 40 may display directions to and/or from the destination (see FIGS. 8 and 12). Upon option 126 being selected, processor 40 may provide a map displaying the location of the destination (see FIG. 13). Upon option 128 being selected, processor 40 may initiate a phone call with the destination. Upon option 130 being selected, the destination information is uploaded to a contacts database on device 10. Upon option 132 being selected, additional options may be provided to a user (e.g. whether to display results in miles/kilometers, whether to limit the results provided by distance or number of results, route type—such as to avoid traffic congestion, to drive on toll-roads, to take a scenic route, to avoid highways, to take the route with the fewest turns, and/or other route types—and/or other options).

Referring to FIG. 8, upon a user selecting option 124 (see FIG. 7), an image 150 of driving directions may be displayed as textual directions. According to some embodiments, image 150 may include a series of directions 154 listed in a textual format. Image 150 may include a toggle input interface 152 that permits a user to toggle between a textual display (such as is illustrated in FIG. 8), and a graphical display (such as is illustrated in FIG. 12). The user may be provided with information such as the total distance, total estimated travel time, subsequent action steps, and so on. Other information may also be provided.

Referring to FIG. 12, a graphical display, shown as image 170, of directions to/from a destination may include a route 172 superimposed upon a map 173 and a toggle input interface 174 to permit users to toggle between textual and graphical displays. Image 170 also may include a menu 175 of options from which a user may choose in order to obtain additional information. When directions are displayed on a map, the map may be rotated such that it faces the direction in which device 10 is traveling and/or the direction in which the user is facing (e.g. so that the map portion at the top of the display corresponds to the view that is in front of the user). A map 173 may be displayed in a perspective view (e.g. an angled view) displayed from the perspective of a direction in which the user is traveling.

Referring to FIG. 13, an image 176 according to some embodiments is shown. As shown in FIG. 13, image 176 may include a map 177 showing a specific location 178. Image 176 also may include location information, shown as address 179, for the specific location 178. Image 176 may be provided, for example, when a user conducts a location-based search from image 50 that is based on a specific location (e.g., a single street address).

Referring now to FIG. 14, a flowchart illustrating steps that may be used to performing an exemplary location-based search from a main image 50 of a mobile computing device includes, at step 180, providing an image portion for location-based searching having a user input field(s) as a part of main image 50 (e.g. from processor 40). The user input field may include, among others, any of the user input fields discussed herein (e.g. the fields discussed with respect to FIGS. 4 and 5).

At step 182, device 10 receives the location-based search query via the user input field (e.g., user input fields 64, 66 shown in FIG. 4) and in response to an initiation request from the user, initiates the location-based search based upon the search query and the present location of device 10.

At step 184, processor 40 communicates with the location application (e.g. GPS application 44) to determine the present location of device 10. As discussed above, if the location of the device 10 cannot be determined, processor 40 may prompt the user to manually input the location or utilize a default location.

At step 186, the location-based search results (i.e., location-based data) are generated. The results may be generated using a fully on-board configuration, an off-board configuration, or a hybrid configuration, as discussed above.

At step 188, the search results are displayed on display 18. The results may be displayed either textually (see, e.g. FIG. 6), or graphically (see e.g. FIGS. 9, 10, and 13). Further, a user may toggle between textual and graphical result images.

At step 190, device 10 receives a selection of one of the results via the results display and/or input device 20 and processor 40 provides a menu of options (see FIGS. 7 and 11).

At step 192, device 10 receives a selection of one of the menu options and processor 40 performs the appropriate action, e.g., places a phone call, provides directions to/from a destination, adds destination information to a contacts database, etc. (see FIGS. 8 and 12).

At step 194, the user may choose to return to the results list, or return to main image 50 and perform another location-based search or other operation.

According to any of the various embodiments, additional information may be displayed along with the location-based search results shown in the Figures. For example, in addition to the results satisfying a specific search query, additional points of interest (e.g., restaurants, banks, hospitals, ATM's etc.) located in the geographic area of the results may additionally be provided, e.g., as separate icons in one or more images provided on display 18. Further, while the results shown in the various embodiments are provided via display 18, according to various alternative embodiments, device 10 may instead, or in addition, provide location-based search results audibly to a user (e.g., via a simulated voice application and a speaker such as loudspeaker 26 shown in FIG. 2). Also, while the inputs have been shown as being manually entered by a user (e.g. with buttons, a touch screen, etc.), the system may be configured to receive voice commands as inputs.

### Initiating LBS from Contacts and Other Text

Location-based data from database 42 may be provided in response to a request initiated by a user. The request may comprise a user selecting a link (an icon, an embedded function/application call, etc.) that is associated with an address. Upon receiving the request, processor 40 provides one or more types of location-based data for the address. Various embodiments of providing location-based data are discussed in more detail below.

Referring to FIGS. 4-11, processor 40 can be configured to recognize or identify addresses or address-related information (e.g., a name associated with an address) within text (e.g., text strings) that may be embedded within a variety of formats (e.g., a data field for a contacts application, an email, a text message, a word processing document, a web page, etc.). Text can be received wirelessly from a remote device (e.g., during a synch operation), loaded from an on-board memory or memory card, or received as user input. Processor 40 may provide a selectable/activatable link (e.g., an icon, a selectable portion of text, an embedded function/application call, etc.) associated with the address (or address-related information), that permits users to initiate a request for location-based data by selecting the link. Upon receiving a selection of the link, or a subsequent link provided by clicking (e.g., right-clicking or left-clicking) the link, processor 40 generates and provides location-based data in one or more formats (as discussed in more detail above). The location-based data is provided based upon the address associated with the link and, in one exemplary embodiment, the current location of device 10 (e.g., the location-based data may or may not be a function of the location of device 10).

Referring to FIG. 15, according to some embodiments, processor 40 is configured to provide a selectable link for one or more fields associated with a contact stored by contacts application 48. As shown in FIG. 15, contacts application 48 may be configured to store and permit access to various types of contact information regarding individuals, entities, etc. For example, for each contact, contacts application 48 may permit a user of device 10 to store, among other information, a name, a phone number (home, work, etc.), an e-mail address, a street address, etc. Contacts application 48 may permit a user of device 10 to view the contact information, either for multiple contacts at a time, or for a single contact.

An image 250 containing contact information for a single contact is shown. Image 250 includes an address field 252. Image 250 may optionally further include additional fields such as a phone field, a text message field, an email field, an instant message field, etc. Field 252 may include an address 64 comprising a street address 254, a city 256, a state 58, and/or a zip code 60. According to various alternative embodiments, address 64 may include more or less information than that shown in FIG. 15. For example, address 64 may include only a city and/or state, or may include a country in addition to or instead of other information, etc. For the purposes of this disclosure, the various possible combinations of one or more of a street address, city, state, zip code, country, etc. are herein referred to as an “address” (e.g., such that a city name such as “New York” may be an address), unless otherwise specified. Other data stored with the address (e.g., a name, phone number, etc.) can be associated with the address by contacts application 48. Link 62 may be a hypertext link, a hot link, or some other type of link.

According to some embodiments, field 252 comprises a link 62 (e.g., an icon, a selectable portion of text, an embedded application/function call, etc.). This link may be associated with the information in address field 252 and the particular contact, and may or may not be visible to the user. Link 62 is selectable by a user (e.g., by highlighting, clicking on, touching with stylus 24, etc.). Link 62 may comprise the text of address 64. According to some embodiments, link 62 may include a selectable icon displayed in or near address field 252. Selection of link 62 by a user initiates a request for location-based data.

As illustrated, link 62 may be provided in address field 252. According to various alternative embodiments, link 62 may be provided as a part of one or more of the other fields associated with a particular contact. According to some embodiments, a user may select any data field for a given contact in order to initiate the request for location-based data. According to some embodiments, a user may be provided with a menu of options upon selecting link 62 (e.g. prompting a user to indicate whether to provide location-based data for the contact, to navigate to a contact, to automatically place a phone call to the contact, to share contact information with another user, to invite a contact to a meeting or fill in some other field in a contacts application, and/or to take some other action).

According to some embodiments, processor 40 is configured to recognize or identify addresses that are embedded within text that may be provided in a variety of formats, including emails, text messages, word processing documents, web pages, etc. Processor 40 may compare text to be displayed on device 10 with the contents of contacts application 48 (or other application or record or file accessible by an application storing similar information such as an address). If processor 40 recognizes a portion of the text as being the same as the information stored in a data field for contacts application 48, processor 40 provides a selectable link when displaying the text such that a user may initiate a request for location-based data by selecting the link.

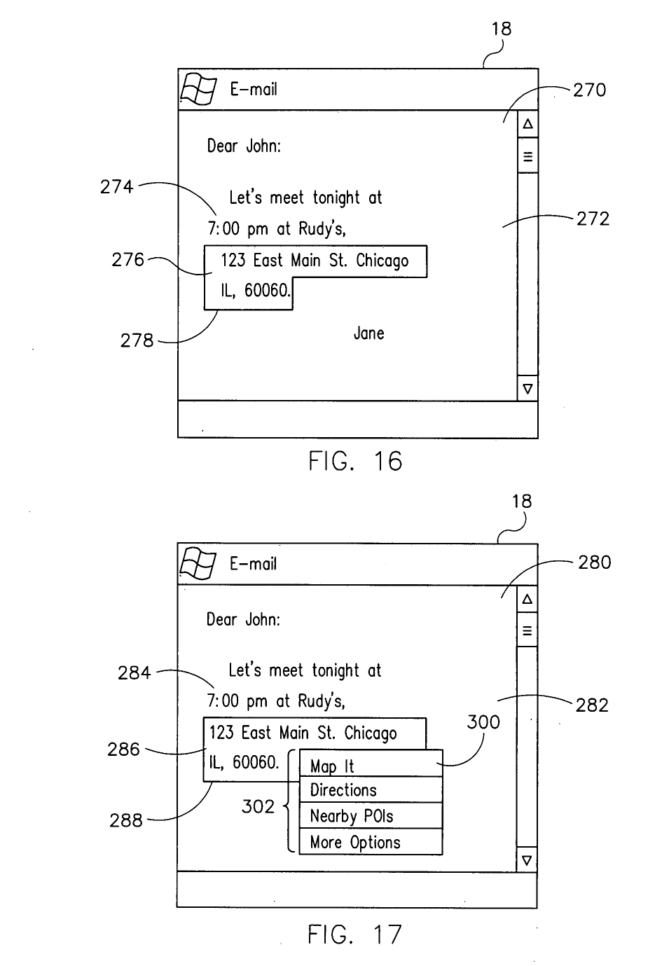

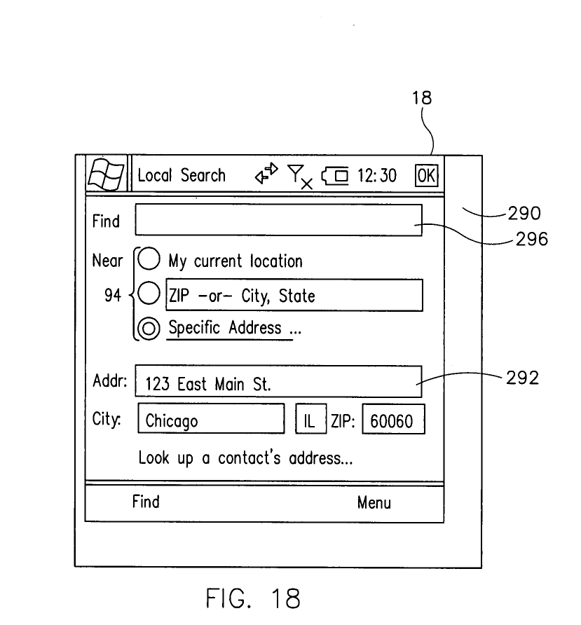

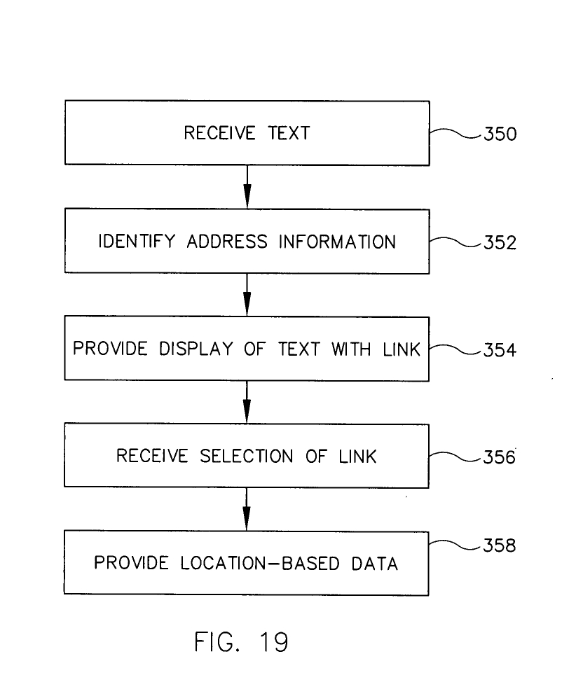

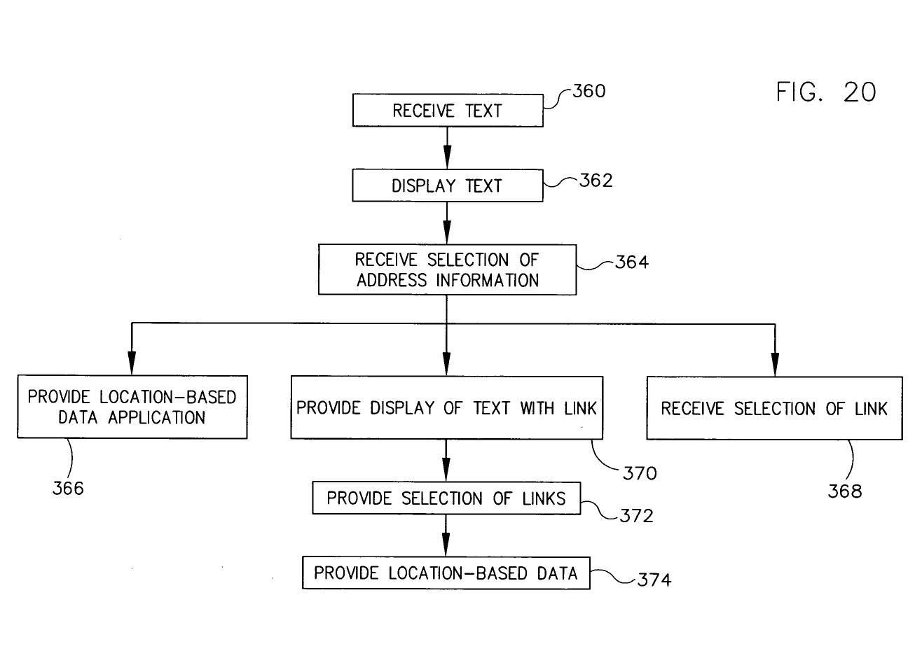

Referring to FIG. 16, an image 270 of an email message 272 is shown. Message 272 may include text 274 having address data 276. Processor 40 may compare text 274 to the information stored by contacts application 48 (e.g., information such as that illustrated in FIG. 15), and provides a selectable link (e.g. link 278) upon recognizing matching information. According to some embodiments, processor 40 may be configured to recognize other address-related information (e.g., other data related to a particular address stored by contacts application 48). For example, if a name appears in a text string, and the name is associated with an address stored by contacts application 48, processor 40 may provide a selectable link for the name, with the link being associated with both the name and the address.

Referring to FIG. 17, according to another alternative embodiment, processor 40 utilizes a parsing algorithm to parse text and identify addresses within the text. According to some embodiments, the algorithm may be based on recognizing certain strings of characters, for example, a street address, followed by a comma, followed by a city, followed by a comma, followed by a state, etc. Other known algorithms for parsing text may alternatively (or additionally) be used. After identifying an address, processor 40 may provide a link when displaying the text such that a user may initiate a request for location-based data based upon the address (e.g., by selecting a link associated with the address). For example, an image 280 similar to image 270 (FIG. 16) is provided, except that link 288 is provided in response to processor 40 applying a parsing algorithm to text 284 to identify address 286 (rather than or in addition to comparing text 284 to the information stored by contacts application 48, as described with respect to FIG. 16). Link 288 initiates a request for location-based data when selected by a user.

Referring to both FIGS. 16 and 17, text comparisons and parsing algorithms may be dependent upon the data being analyzed, and whether a portion of text is actually an address may at times remain ambiguous to processor 40 (e.g., as a result of informal or abbreviated address formats). In such a case, processor 40 may highlight or otherwise identify a potential address and provide a user with the ability to specify whether the identified text in fact is an address. For example, if a potential match between a portion of text and information from a contact data field is identified, processor 40 may provide the information from the contact data field in, for example, a pop-up menu and permit the user to verify that processor 40 should provide a link associated with the contact. Other means of permitting a user to confirm whether a potential address identified by processor 40 matches certain contact information may alternatively (or additionally) be used. According to some embodiments, if processor 40 does not identify an address (e.g., through either a comparison with a contacts application or through a text-parsing algorithm), the user may also manually select address data within text and manually create a link to request location-based data associated with the address data.

Referring to FIGS. 15-17, a user is provided with a selectable link that is associated with an address. According to some embodiments, the link may comprise the text of an address that is displayed in a different manner than other portions of text (if any) displayed with the address. For example, the address may be displayed in a different font type/color/size; may be underlined, italicized, etc.; may be shaded, highlighted, etc., and so on. Further, a selectable icon (e.g., a balloon, pointer, etc.) may be provided as a link adjacent to the address. Processor 40 may permit a user to initiate a request for location based data by selecting the link.

According to some embodiments, upon a user initiating a request for location-based data, processor 40 launches a location-based data application, as shown in FIG. 18. Referring to FIG. 18, processor 40 provides an image 290 for the location-based data application that includes user input fields 292, 296 that, according to some embodiments, are configured to receive text input from a user. Processor 40 may use the text to provide location-based data to the user. According to some embodiments, as a result of a user selecting a link such as link 288 shown in FIG. 17, image 290 is displayed with one or more of user input fields 292, 296 automatically populated with the address data or other information associated with the link. A user may then perform a location-based search without the need to manually enter any additional data into the location-based data application.

According to some embodiments, initiating a request for location-based data results in processor 40 providing a menu of options to a user. For example, referring back to FIG. 17, a menu 100 of options 102 may be provided, including the options to map the location of the address, get driving directions to and/or from the address, identify nearby points of interest, or other options (e.g., adding an address to a contacts database, placing a phone call to a phone number associated with the address, etc.).

Once the location-based search is initiated, processor 40 can utilize the address associated with the selected link to search location information database 42 for location-based data satisfying the search parameters. According to various alternative embodiments, the location-based data may be based not only on an address, but on the current location of device 10, as discussed above. The search may be conducted as disclosed above, by any of the systems discussed above, and/or by some other method or system. The results of the search may be provided in any of the formats discussed above or in some other format.

Referring now to FIG. 19, a flow chart is shown that illustrates the process of providing location-based data based on a request initiated by a selectable link according to some exemplary embodiments. At step 1250, processor 40 receives text to be displayed on display 18. The text may be part of an email, a text message, a word processing document, a web page, etc. At step 1252, processor 40 identifies an address (or address-related information) using one of the methods described herein or any other suitable method. At step 1254, upon identifying the address, processor 40 displays the text with a selectable link associated with the address. The link may comprise the address or may be any other selectable link, icon, etc. At step 1256, processor 40 receives a selection of the link and a request for location-based data is initiated. At step 358, in response to the request for location-based data, processor 40 generates the location-based data and provides the location based data to a user, for example, in one or more of the formats illustrated herein.

As discussed with respect to FIGS. 15-17 and 19, processor 40 recognizes or identifies an address with text for which to provide a selectable link. According to some embodiments, processor 40 permits a user to manually select or identify (e.g., by highlighting) addresses within text. Processor 40 may then provide a link for the selected text and/or provide location-based data based upon the address identified by the user.

A flowchart illustrating an exemplary process for LBS according to some embodiments is shown in FIG. 20. At step 360, processor 40 displays text via display 18. As discussed above, the text may be part of an email, a text message, a word processing document, a web page, etc. At step 362, processor 40 receives an identification of an address or address-related information from a user (e.g., by the user highlighting or otherwise identifying a portion of text). At step 364, processor 366 initiates a location-based search based upon the address. At steps 366, 368, 1270, processor 40 may perform one or more actions, including launching a location-based data application with user input fields automatically populated (step 366), providing location-based data in a graphic, textual, or other format (step 368), or displaying the text with a selectable link such that a user may select the link at a subsequent time (step 1270). Upon receiving a selection of the link at a subsequent time (step 1272), processor 40 then provides the location-based data associated with the link (step 1274).

While the detailed drawings, specific examples and particular formulations given describe exemplary embodiments, they serve the purpose of illustration only. The hardware and software configurations shown and described may differ depending on the chosen performance characteristics and physical characteristics of the computing devices. The systems shown and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

### Saving LBS Result

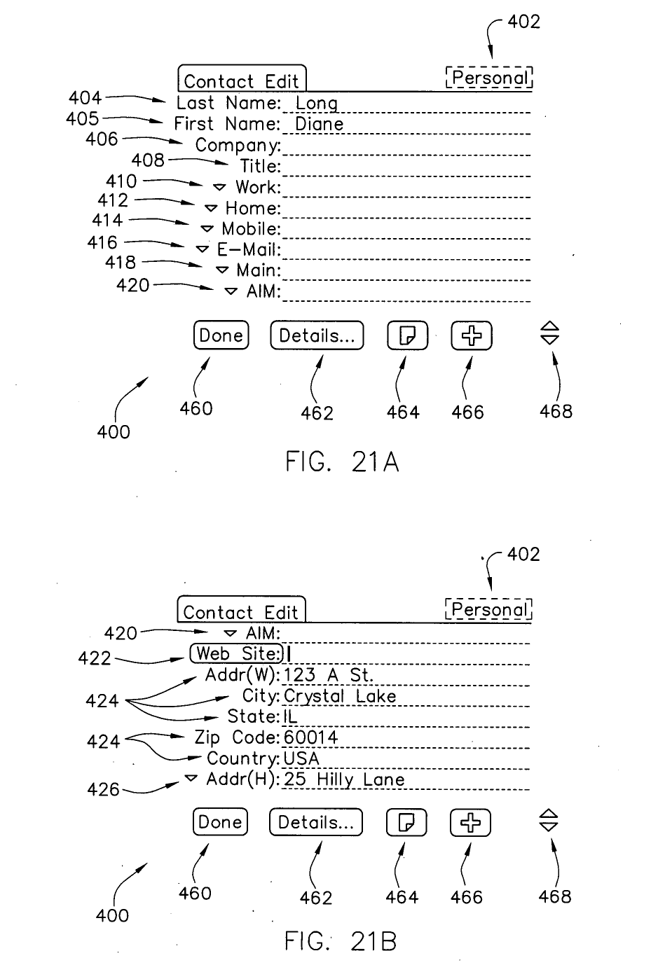

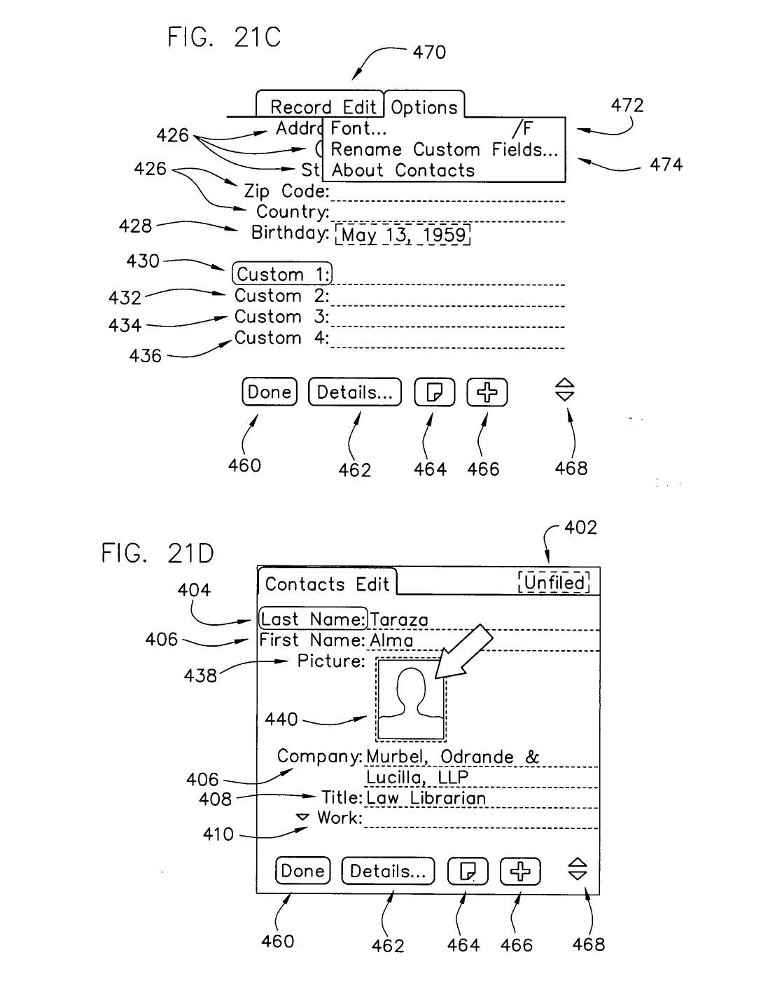

Referring back to FIG. 7 and to FIGS. 21A-D, once a search result 104 (e.g. point of interest (POI)) is found by the location based search (LBS), a user may take other actions based on the LBS results 104 (e.g. by opening and selecting from a menu of options). One such action is to save an LBS result. The LBS result 104 may be saved in any number of applications including an application that includes a contacts function (e.g. a contacts application 48—FIG. 1). A user may initiate saving of an LBS search by choosing an option from a menu (e.g. menu option 132), by a voice command, by selected keystrokes, and/or by some other input. The application including a contacts function may be a primary contacts program of the device 10 or may be a secondary application that also includes a contact function. A primary contacts function may allow a user to store custom contacts and/or may synchronize with a contacts application of a remote device (e.g. the contacts function of the MS Outlook application).

When a user saves an LBS result to a contacts application 48, processor 40 may be configured to automatically populate fields of the contact application based on information provided by location information database 42. Examples of fields that could be populated include contact information (e.g. name/identifier 404-405, telephone number 410-414, fax number, e-mail address 416, street address 424-426, an instant message contact information 420, an instant message ID, and/or other contact information for the selected LBS result 104,400) and may include non-contact information. The non-contact information may include contact identifier information (e.g. a special ring tone, a picture 438-440, and/or other contact identifier information), may include operation information (e.g. operating hours, menu, events scheduled at the location, manager's name, a web site address 422, custom fields 430-436, etc.), may include system information (whether the contact 400 should be private, whether the contact 400 should be transferred to other devices, a category 402 to assign the contact 400, etc.), and/or may include various other non-contact information. The contact 400 may include multiple entries of a single type of information. For example, a single contact may include multiple addresses 424,426 for LBS results having more than one location (if desired by a user), multiple phone numbers 410-414, and/or multiples of any other information. When an LBS result is saved as a contact, one or more of the custom fields 430-436 may be automatically renamed based on the information from the LBS result stored in the custom field.

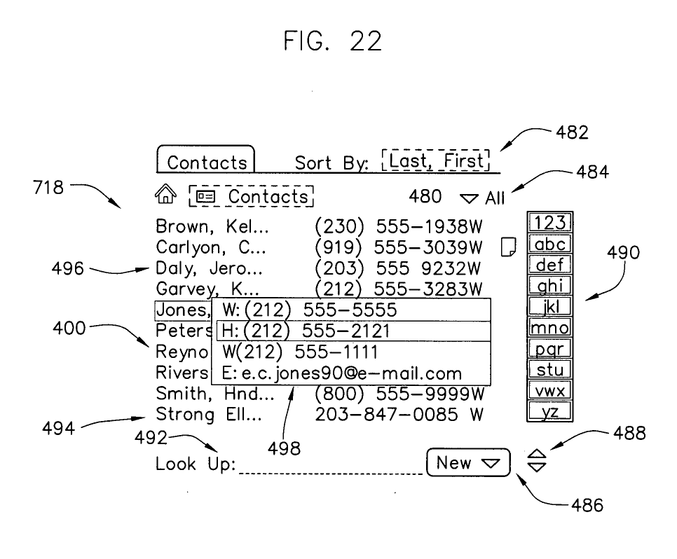

Processor 40 may be configured to populate fields in the contact application with information not received from database 42. For example, processor 40 may be configured to automatically assign the newly created LBS result to a category/group 402 in the contacts application 48 (e.g. processor 40 may assign all LBS contacts 400 to an “LBS” group, processor 40 may assign a new restaurant contact from an LBS search to a “restaurant” group, etc.). A user may be allowed (e.g. prompted) to add or switch categories 402 to which an LBS contact 400 is assigned. As another example of adding information not from database 42, if an address already in a user's contact application 48 was used to initiate the LBS (e.g. a search for a location proximate to the address of a contact 496 (FIG. 22) in the contact application 718), then a link or note (either visible or not visible to a user) may be added to the saved LBS contact 400 and/or the contact 496 (FIG. 22) used to initiate the LBS. As still another example, data based on search terms used to generate the LBS results may be added to the saved LBS contact 400. As other examples, various non-contact system information may be added to a contact.

Saved LBS contacts 400 can be used in any number of ways, including the ways in which other contacts 496 are used and/or ways unique to the LBS contacts 400. A user may be given an option to navigate to a saved LBS contact 400, may be given an option 251 (FIG. 15) to initiate a phone call to a saved LBS contact 400, may be given an option 253 (FIG. 15) to e-mail a saved LBS contact 400, may be given an option to open an LBS contact's website (e.g. a reservation website), and/or may be given some other options based on information saved in an LBS contact 400. These options may be provided in the contacts application 48,718 (e.g. a link is provided on the relevant information which a user can select to initiate the action, a user can open a menu which provides the options, etc.) or can be provided in other applications that access the contacts application (e.g. an e-mail application can access the contacts application to determine an e-mail address and/or to allow e-mail based on a partially entered contact name; a phone application can access the contacts application to identify contacts corresponding to a user input such as a partial or full name, a partial phone number, or some other user input; a calendar application can access a contacts application to fill in information for a field of an event such as attendees to invite, location, or some other field; a navigation application may access a contact application to identify a desired destination; an LBS application may access a contact application to provide results and/or obtain a location from which to base the search; and/or the contacts application may be used by various other applications.

In some embodiments, in subsequent searches, processor 40 may be configured to check saved LBS contacts 400 for matches to the search parameters. Results corresponding to a saved LBS contact 400 may be ranked higher in a hierarchy of results displayed to, a user than a result not matching a saved contact.

### Other Features

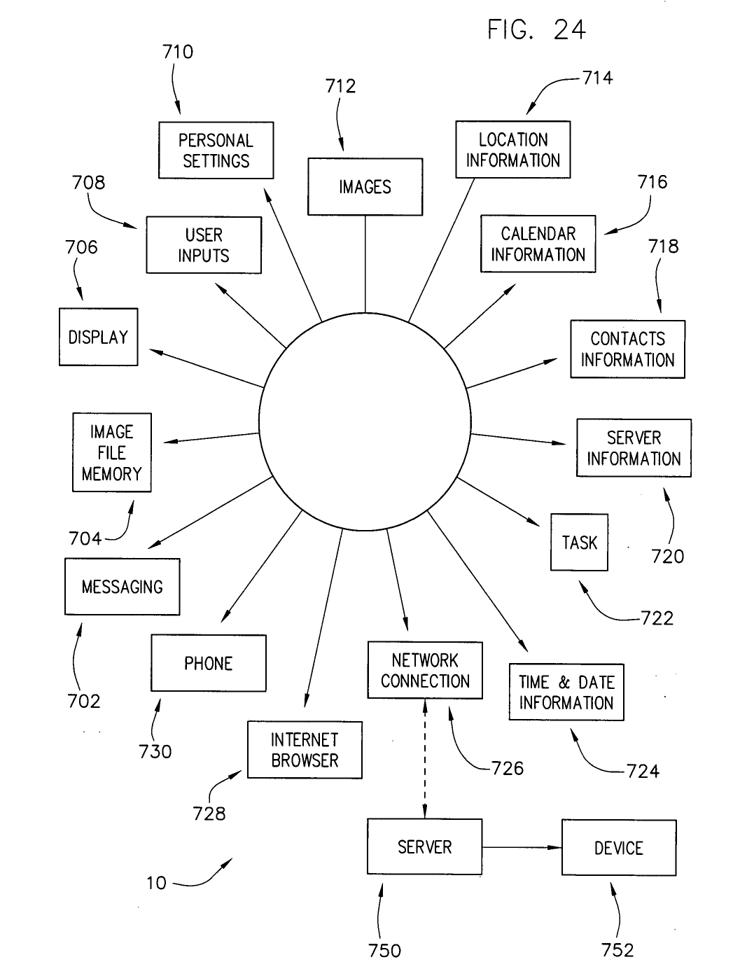

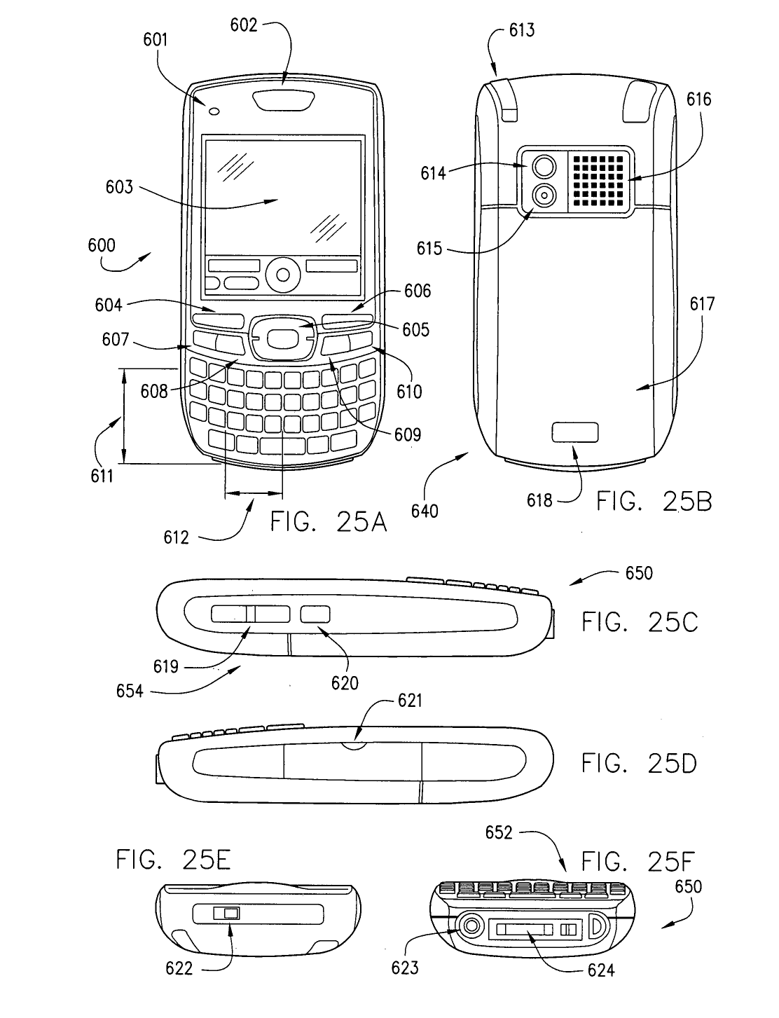

Referring back to FIGS. 21A-B, the various fields 410-426 can be exchanged with other fields such that each contact may display unique fields. For example, the contacts application 718 (FIG. 24) may give the user control options 421 that allow a user to choose field categories from a list of fields. A user may be allowed to add or remove fields (e.g. using a field selection control option 466). A user may be given various control options 464-468 such as a scrolling control option 468 that allows a user to scroll through the list of fields for the contact, a note control option 464 that allows a user to add and/or review notes relating to the contact. A user may also open a menu 470 that gives the user additional control options, such as a font control option 472 that allows a user to control a font used in a field of the contact, and a fields option 474 that allows a user to rename fields (e.g. custom fields named by a user) for the contact.

Referring to FIG. 22, a contacts application 718 may provide a user with various control options 482, 484, 490, 492 that allow a user to sort/filter a list of contacts 494 and/or find particular contacts 400,496. A control option 484 may allow the contacts listed to be limited by categories, a control option 482 may allow a user to control the method used to arrange (or order) contacts that are displayed, a control option 492 may allow a user to limit contacts based on search terms, and/or a control option 490 may allow contacts to be filtered alphabetically (e.g. in groups of letters). A control option 486 may allow a user to create a new contact or other entry. A set of control options 498 may be displayed which allow a user to take action relating to a contact (place a call to, send an e-mail to, send a text message to, navigate to, create a meeting request involving, perform a location based search based on, access a website of, and/or take some other action relating to the contact).

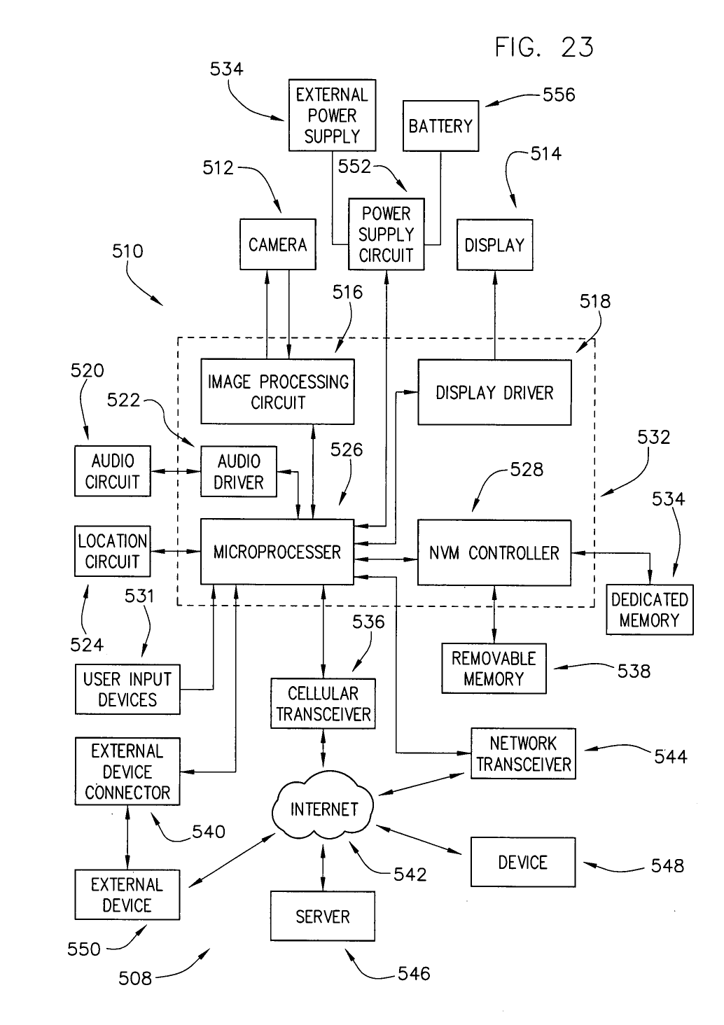

Referring to FIG. 23, portable device 510 may be a mobile computing device capable of executing software programs. The device 510 may be implemented as a combination handheld computer and mobile telephone, sometimes referred to as a Smartphone. Examples of Smartphones include, for example, Palm® products such as Palm® Treo™ Smartphones. Although some embodiments may be described with portable device 510 implemented as a Smartphone by way of example, it may be appreciated that the embodiments are not limited in this context. For example, portable device 510 may comprise, or be implemented as, any type of wireless device, mobile station, or portable computing device with a self-contained power source (e.g., battery) such as a laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, camera, pager, messaging device, data communication device, and so forth.

Processing circuit 532 of hand-held device 510 may include one or more of a microprocessor 526, image processing circuit 516, display driver 518, NVM controller 528, audio driver 522 (e.g. D/A converter, A/D converter, an audio coder and/or decoder (codec), amplifier, etc.), and other processing circuits. Processing circuit 532 can include various types of processing circuitry, digital and/or analog, and may include one or more of a microprocessor, microcontroller, application-specific integrated circuit (ASIC), field programmable gate array (FPGA), or other circuitry configured to perform various input/output, control, analysis, and other functions. In various embodiments, the processing circuit 532 may include a central processing unit (CPU) using any suitable processor or logic device, such as a as a general purpose processor. Processing circuit 532 may include, or be implemented as, a chip multiprocessor (CMP), dedicated processor, embedded processor, media processor, input/output (I/O) processor, co-processor, a microprocessor such as a complex instruction set computer (CISC) microprocessor, a reduced instruction set computing (RISC) microprocessor, and/or a very long instruction word (VLIW) microprocessor, a processor implementing a combination of instruction sets, a controller, a microcontroller, an application specific integrated circuit (ASIC), a field programmable gate array (FPGA), a programmable logic device (PLD), or other processing device in accordance with the described embodiments.

Processing circuit 532 may be configured to digitize data, to filter data, to analyze data, to combine data, to output command signals, and/or to process data in some other manner. Processing circuit 532 may be configured to perform digital-to-analog conversion (DAC), analog-to-digital conversion (ADC), modulation, demodulation, encoding, decoding, encryption, decryption, etc. Processing circuit 532 (e.g. microprocessor 526) may be configured to execute various software programs such as application programs and system programs to provide computing and processing operations for device 510.

Processing circuit 532 may also include a memory that stores data. Processing circuit may include only one of a type of component (e.g. one microprocessor), or may contain multiple components of that type (e.g. multiple microprocessors). Processing circuit 532 could be composed of a plurality of separate circuits and discrete circuit elements. In some embodiments, processing circuit 532 will essentially comprise solid state electronic components such as a microprocessor (e.g. microcontroller). Processing circuit 532 may be mounted on a single board in a single location or may be spread throughout multiple locations which cooperate to act as processing circuit 532. In some embodiments, processing circuit 532 may be located in a single location and/or all the components of processing circuit 532 will be closely connected.

Components shown as part of a single processing circuit 532 in the figures may be parts of separate processing circuits in various embodiments covered by the claims unless limited by the claim to a single processing circuit (e.g. location circuit 524 may be part of a separate assembly having a separate microprocessor that interfaces with processing circuit 532 through data port 540).

Hand-held device 510 may also include a network transceiver 544. Transceiver 544 may operate using one or more of a LAN standard, a WLAN standard, a Bluetooth standard, a Wi-Fi standard, an Ethernet standard, and/or some other standard. Network transceiver 544 may be a wireless transceiver such as a Bluetooth transceiver and/or a wireless Ethernet transceiver. Wireless transceiver 544 may operate using an IEEE 802.11 standard. Hand-held device 510 may also include an external device connector 540 (such as a serial data port) for transferring data. External device connector 540 may also serve as the connector 554 to an external power supply. Hand-held device may contain more than one of each of transceiver 544 and external device connector 540. For example, network transceiver 544 may include both a Bluetooth and an IEEE 802.11 transceiver.

Network transceiver 544 may be arranged to provide voice and/or data communications functionality in accordance with different types of wireless network systems. Examples of wireless network systems may include a wireless local area network (WLAN) system, wireless metropolitan area network (WMAN) system, wireless wide area network (WWAN) system, and so forth. Examples of wireless network systems offering data communication services may include the Institute of Electrical and Electronics Engineers (IEEE) 802.xx series of protocols, such as the IEEE 802.11a/b/g in series of standard protocols and variants (sometimes referred to as “WiFi”), the IEEE 802.16 series of standard protocols and variants (sometimes referred to as “WiMAX”), the IEEE 802.20 series of standard protocols and variants, and so forth.

Hand-held device 510 may be capable of operating as a mobile phone. The mobile phone may use transceiver 544 and/or may use a cellular transceiver 536. Cellular transceiver 536 may be configured to operate as an analog transceiver, a digital transceiver (e.g. a GSM transceiver, a TDMA transceiver, a CDMA transceiver), or some other type of transceiver. Cellular transceiver 536 may be configured to transfer data (such as image files) and may be used to access the Internet 542 in addition to allowing voice communication. Cellular transceiver 536 may be configured to use one or more of an EV-technology (e.g. EV-DO, EV-DV, etc.), an EDGE technology, a WCDMA technology, and/or some other technology.

Transceiver 544 may be arranged to perform data communications in accordance with different types of shorter range wireless systems, such as a wireless personal area network (PAN) system. One example of a wireless PAN system offering data communication services includes a Bluetooth system operating in accordance with the Bluetooth Special Interest Group (SIG) series of protocols, including Bluetooth Specification versions v1.0, v1.1, v1.2, v2.0, v2.0 with Enhanced Data Rate (EDR), etc.—as well as one or more Bluetooth Profiles, etc. Other examples may include systems using an infrared technique.

Cellular transceiver 536 may provide voice communications functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth.

In addition to voice communications functionality, the cellular transceiver 536 may be arranged to provide data communications functionality in accordance with different types of cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and so forth.

Hand-held device 510 may include one or more user input devices 531 (e.g. button, switch, touch screen, keyboard, keypad, voice command circuit, etc.) for registering commands from a user on device 510. Some or all of user input devices 531 may interface with a switch control circuit (not shown) configured to interpret which switches have been actuated. User input device 531 may include an alphanumeric keyboard. The keyboard may comprise, for example, a QWERTY key layout and an integrated number dial pad. A keyboard integrated into a hand-held device would typically be a thumb keyboard. User input device 531 may also include various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, and so forth. Any of user input devices 531 may be concealable behind a body (e.g. a sliding body, a flip-out body, etc.) such that they are hidden when the body is in a first position and visible when the body is in the second position.

Hand-held device 510 may include one or more location determining circuits 524 (e.g. a GPS circuit and/or a cell-based location determining circuit) configured to determine the location of device 510. Device 10 may be configured to receive inputs from more than one location determining circuit 524. These inputs can be compared such that both are used, one (e.g. a cell-based system) can be used primarily when the other (e.g. GPS) is unable to provide reliable location information, or can have some other functional relationship.

Device 510 may use one or more different location determining techniques to derive the location of the device 510 based on the data from location determining circuit 524.

For example, device 510 may use one or more of Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFTL) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), and so forth.

Device 510 may be arranged to operate in one or more position determination modes including, for example, a stand-alone mode, a mobile station (MS) assisted mode, and/or a MS-based mode. In a stand-alone mode, such as a stand-alone GPS mode, the mobile computing device 5100 may be arranged to autonomously determine its position without network interaction or support. When operating in an MS-assisted mode or an MS-based mode, however, device 510 may be arranged communicate over a radio access network (e.g., UMTS radio access network) with a position determination entity (PDE) such as a location proxy server (LPS) and/or a mobile positioning center (MPC).

In an MS-assisted mode, such as an MS-assisted AGPS mode, the PDE may be arranged to determine the position of the mobile computing device. In an MS-based mode, such as an MS-based AGPS mode, device 510 may be arranged to determine its position with only limited periodic assistance from the PDE. In various implementations, device 510 and the PDE may be arranged to communicate according a suitable MS-PDE protocol (e.g., MS-LPS or MS-MPC protocol) such as the TIA/EIA standard IS-801 message protocol for MS-assisted and MS-based sessions in a CDMA radiotelephone system.

When assisting device 510, the PDE may handle various processing operations and also may provide information to aid position determination. Examples of assisting information may include satellite-based measurements, terrestrial-based measurements, and/or system-based measurements such as satellite almanac information, GPS code phase measurements, ionospheric data, ephemeris data, time correction information, altitude estimates, timing offsets, forward/reverse link calibration, and so forth.

In various implementations, the assisting information provided by the PDE may improve the speed of satellite acquisition and the probability of a position fix by concentrating the search for a GPS signal and/or may improve the accuracy of position determination. Each position fix or series of position fixes may be available at device 510 and/or at the PDE depending on the position determination mode. In some cases, data calls may be made and assisting information may be sent to device 510 from the PDE for every position fix. In other cases, data calls may be made and assistance information may be sent periodically and/or as needed.

Hand-held device 510 may include one or more audio circuits 520 (e.g. speakers, microphone, etc.) for providing or receiving audio information to or from a user. In one example, hand-held device 510 includes a first speaker 520 designed for regular phone operation. Hand-held device 510 may also include a second speaker 520 for louder applications such as speaker phone operation, music or other audio playback (e.g. an mp3 player application), etc. Hand-held device 510 may also include one or more audio ports 520 (e.g. a headphone connector) for output to an external speaker and/or input from an external microphone. Audio circuit 520 may be under the control of one or more audio drivers 522 which may include D/A converters and/or an amplifier.

Hand-held device 510 may include a camera 512 for taking pictures using device 510. Camera 512 may include a CCD sensor, a CMOS sensor, or some other type of image sensor capable of obtaining an image (particularly, images sensors capable of obtaining an image formed as an array of pixels). The image sensor may have a resolution of at least about 65,000 pixels or at least about 1 megapixel. In some embodiments, the image sensor may have a resolution of at least about 4 megapixels. Camera 512 may also include read-out electronics for reading data from the image sensor. Image processing circuit 516 may be coupled to the camera 512 for processing an image obtained by the camera. This image processing may include format conversion (e.g. RGB to YCbCr), white balancing, tone correction, edge correction, red-eye reduction, compression, CFA interpolation, etc. Image processing circuit 516 may be dedicated hardware that has been optimized for performing image processing.

Hand-held device 510 may include a display 514 for displaying information to a user. Display 514 could be one or more of an LCD display (e.g. a touch-sensitive color thin-film transistor (TFT) LCD screen), an electroluminescent display, a carbon-nanotube-based display, a plasma display, an organic light emitting diode (OLED) display, and some other type of display. Display 514 may be a touch screen display such that a user may input commands by approaching (e.g. touching) display 514 (including touch screens that require a specialized device to input information). Display 514 may be a color display (e.g., 16 or more bit color display) or may be a non-color (e.g. monotone) display. Display 514 may be controlled by a display driver 518 that is under the control of a microprocessor 526. In some embodiments, display 514 may be used with a stylus. Display 514 may be used as an input to a handwriting recognizer application.

Hand-held device 510 may include a dedicated memory 534 fixed to device 510. Memory 534 may be implemented using any machine-readable or computer-readable media capable of storing data such as erasable or non-erasable memory, writeable or re-writeable memory, and so forth. Dedicated memory 534 may be a non-volatile memory, may be a volatile memory, or may include both volatile and non-volatile memories. Examples of machine-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information. In one embodiment, fixed memory 534 is a non-volatile memory.

Although the memory 534 is shown as being separate from and external to processing circuit 532 some portion or the entire memory 534 may be included on the same integrated circuit as processing circuit 532 (e.g. the same integrated circuit as microprocessor 526).

Hand-held device 510 may include a removable memory port 538 configured to receive a removable memory medium, and/or other components. Removable memory port 538 may also serve as an external device connector 540. For example, removable memory port may be an SDIO card slot which can be used to receive memory cards, receive cards input and/or output data, and combined cards having both memory and input/output functions.

Memory 534 and/or memory 538 may be arranged to store one or more software programs to be executed by processing circuit 532.

Dedicated memory 534 and removable memory 538 may be connected to and/or under the control of a common memory controller 528 such as a non-volatile memory controller. Memory controller 528 may be configured to control reading of data to and writing of data from dedicated memory 534 and/or removable memory 538.

Handheld device 510 may be configured to connect to one or more servers 546,548 via a network 542 (such as the Internet) using one or more of network transceiver 544, cellular transceiver 536, and external device connector 540.

Hand-held device 510 may also include a power supply circuit 552 configured to regulate power supply in hand-held device 510. Power supply circuit 552 may be configured to do one or more of control charging of battery 556, to communicate the amount of power remaining in battery 556, determine and/or communicate whether an external power supply is connected, switch between the external power supply and the battery, etc. Battery 556 may be a rechargeable battery and may be removable or may be fixed to device 510. Battery 556 may be formed from any number of types of batteries including silver-based batteries (e.g. silver-zinc, magnesium-silver-chloride, etc.), a lithium-based battery (e.g. lithium-ion, lithium-polymer, etc.), a nickel-based battery (nickel-cadmium, nickel-metal-hydride, etc.), zinc-based batteries (e.g. silver-zinc, carbon-zinc, etc.), etc. External power supply connector 554 may be configured to be connected to a direct current source, an alternating current source, or both DC and AC sources.

Device 510 may have an optical viewfinder (not shown), may use display 514 as a digital viewfinder, may include some other type of view finder, may include multiple types of view finders, or may not include a view finder.

Device 510 may be configured to connect to the Internet 542, which may be a direct connection (e.g. using cellular transceiver 536, external device connector 540, or network transceiver 544) or may be an indirect connection (e.g. routed through external device 550). Device 510 may receive information from and/or provide information to the Internet. Device 510 may include a web browser configured to display information received from the Internet 542 (including information which may be optimized by the browser for display on portable device 510). Device 510 may connect to one or more remote servers 546, 548 using the Internet 542. Device 510 could also connect to another personal electronic device 550 by way of the Internet 542.

Device 510 may comprise an antenna system (not illustrated) for transmitting and/or receiving electrical signals. Each of the transceivers 536,544 and/or location circuit 524 may include individual antennas or may include a common antenna system. The antenna system may include or be implemented as one or more internal antennas and/or external antennas.

Portable device 510 may comprise a subscriber identity module (SIM) coupled to processing circuit 532. The SIM may comprise, for example, a removable or non-removable smart card arranged to encrypt voice and data transmissions and to store user-specific data for allowing a voice or data communications network to identify and authenticate the user. The SIM may store data such as personal settings specific to the user.

Referring to FIG. 24, device 510 and/or processing circuit 532 may be configured to run any number of different types of applications. Examples of application programs may include, for example, a phone application 730 (e.g. a telephone application, a voicemail application, etc.), a messaging application 702 (e.g. an e-mail application, an instant message (IM) application, a short message service (SMS) application, a multimedia message service (MMS) application), a web browser application 728, a personal setting application 710 (e.g. a personal information manager (PIM) application), a contact management application 718, a calendar application 716 (e.g. a calendar application, a scheduling application, etc.), a task management application 722, a document application (e.g. a word processing application, a spreadsheet application, a slide application, a document viewer application, a database application, etc.), a location application 714 (e.g. a positioning application, a navigation application, etc.), an image application 712 (e.g. a camera application such as a digital camera application and/or a video camera application, an image management application, etc.) including media player applications (e.g. a video player application, an audio player application, a multimedia player application, etc.), a gaming application, a handwriting recognition application, and so forth. The application software may provide a graphical user interface (GUI) to communicate information between the portable device 510 and a user.

Device 510 may include a location application 714. Location application 714 may be configured to calculate the current position (e.g. the rough current position) of device 510 based on data received from one or more location circuits 524. Location application 714 may be provided with map information such that it can translate coordinate positions into map positions (and vice versa). Location application 714 may be configured to provide navigational information to a user such as turn by turn directions.

Device 510 may include personal organizer applications such as a calendar application 716, a contacts application 718, and a task application (not illustrated). Calendar application 716 may allow a user to schedule events, set alarms for events, and store a wide variety of information for events (e.g. name of the event, location of the event, other attendees of the event, etc.). Contacts application 718 may allow a user to save contact information for a contact such as phone number information (which may be shared with a phone application 730), address information, group information (e.g. which user created group or groups the contact belongs to), and other information about the contact. The task application allows a user to keep track of pending and/or completed tasks.

Device 510 may include an internal clock application 724 that keeps track of time information (such as current time of day and/or date), time zone information, daylight savings time information, etc. Clock application 724 may be a program running based on data from an internal clock of microprocessor 526, data from a separate clock/timing circuit, or data from some other circuit.

Device 510 may also include one or more network connection protocol applications 726 that allow a user to transfer data over one or more networks. Network application 726 may be configured to allow device 510 to access a remote device such as server 546,548 or other device 548.

Device 510 may include an Internet browser application 728 that allows a user to browse the internet. The Internet browser application 728 may be configured to alter the data received from Internet sites so that the data can be easily viewed on portable device 510.

Device 510 may include a phone application 730 configured to allow a user to make phone calls. Phone application 730 may use contact information from contact application 718 to place phone calls.

Device 510 may also include one or more messaging applications 702 that allow a user to send and/or receive messages such as text messages, multi-media messages, e-mails, etc. E-mail messages may come from a server which may use a Push technology and/or may use a pull technology (e.g. POP3, IMAP, etc.).

Any of the information discussed above for any of the applications (e.g. applications 702-728) may be added to or otherwise associated with an image file.

Referring to FIGS. 23 and 25A-F, a hand-held portable computing device 600 (e.g. Smartphone) includes a number of user input devices 531. The user input devices include a send button 604 configured to select options appearing on display 603 and/or send messages, a 5-way navigator 605 configured to navigate through options appearing on display 603, a power/end button 606 configured to select options appearing on display 603 and to turn on display 603, a phone button 607 usable to access a phone application screen, a calendar button 608 usable to access a calendar application screen, a messaging button 609 usable to access a messaging application screen, an applications button 610 usable to access a screen showing available applications, a thumb keyboard 611 (which includes a phone dial pad 612 usable to dial during a phone application), a volume button 619 usable to adjust the volume of audio output of device 600, a customizable button 620 which a user may customize to perform various functions, a ringer switch 622 usable to switch the Smartphone from one mode to another mode (such as switching from a normal ringer mode to a meeting ringer mode), and a touch screen display 603 usable to select control options displayed on display 603. Touch screen display 603 is also a color LCD display 514 having a TFT matrix.

Smartphone 600 also includes audio circuits 520. The audio circuits 520 include phone speaker 602 usable to listen to information in a normal phone mode, external speaker 616 louder than the phone speaker (e.g. for listening to music, for a speakerphone mode, etc.), headset jack 623 to which a user can attach an external headset which may include a speaker and/or a microphone, and microphone 625 which can be used to pick up audio information such as the user's end of a conversation during a phone call.

Smartphone 600 also includes a status indicator 601 that can be used to indicate the status of Smartphone 600 (such as messages pending, charging, low battery, etc.), a stylus slot 613 for receiving a stylus such as a stylus usable to input data on touch screen display 603, a digital camera 615 (see camera 512) usable to capture images, a mirror 614 positioned proximate camera 615 such that a user may view themselves in mirror 614 when taking a picture of themselves using camera 615, a removable battery 618 (see battery 556), and a connector 624 (see external data connector 540 and external power supply 554) which can be used to connect device 600 to either (or both) an external power supply such as a wall outlet or battery charger or an external device such as a personal computer, a GPS unit, a display unit, or some other external device.

Smartphone 600 also includes an expansion slot 621 (see removable memory 38) which may be used to receive a memory card and/or a device which communicates data through slot 621, and a SIM card slot 617, located behind battery 618, configured to receive a SIM card or other card that allows the user to access a cellular network.

In various embodiments device 510 and device 600 may include a housing 640. Housing 640 could be any size, shape, and dimension. Housing 640 may be configured to hold a screen in a fixed relationship above a user input device in a substantially parallel or same plane. This fixed relationship may exclude a hinged or movable relationship between the screen and plurality of keys in the fixed embodiment. Device 510 may be a handheld computer, which is a computer small enough to be carried in a typical front pocket found in a pair of pants, comprising such devices as typical mobile telephones and personal digital assistants, but excluding typical laptop computers and tablet PCs. In some embodiments, housing 640 has a width 652 (shorter dimension) of no more than about 200 mm or no more than about 100 mm. According to some of these embodiments, housing 640 has a width 652 of no more than about 85 mm or no more than about 65 mm. According to some embodiments, housing 640 has a width 652 of at least about 30 mm or at least about 50 mm. According to some of these embodiments, housing 640 has a width 652 of at least about 55 mm.

In some embodiments, housing 640 has a length 654 (longer dimension) of no more than about 200 mm or no more than about 150 mm. According to some of these embodiments, housing 640 has a length 654 of no more than about 135 mm or no more than about 125 mm. According to some embodiments, housing 640 has a length 654 of at least about 70 mm or at least about 100 mm. According to some of these embodiments, housing 640 has a length 654 of at least about 110 mm.

In some embodiments, housing 640 has a thickness 650 (smallest dimension) of no more than about 150 mm or no more than about 50 mm. According to some of these embodiments, housing 640 has a thickness 650 of no more than about 30 mm or no more than about 25 mm. According to some embodiments, housing 640 has a thickness 650 of at least about 10 mm or at least about 15 mm. According to some of these embodiments, housing 640 has a thickness 650 of at least about 50 mm.

Referring to FIGS. 1 and 2, a mobile computing device 10 is shown. The teachings herein can be applied to device 10 or to other electronic devices (e.g., a desktop computer), mobile computing devices (e.g., a laptop computer) or handheld computing devices (e.g., a personal digital assistant (PDA), Smartphone, etc.). According to some embodiments, device 10 is a Smartphone, which is a combination mobile telephone and handheld computer having PDA functionality. PDA functionality can comprise one or more of personal information management (e.g., including personal data applications such as email, calendar, phone, text messaging, etc.), database functions, word processing, spreadsheets, voice memo recording, Global Positioning System (GPS) functionality, etc. Device 10 is configured to synchronize personal information from these applications with a computer (e.g., a desktop, laptop, server, etc.). Device 10 is further configured to receive and operate additional applications provided to device 10 after manufacture, e.g., via wired or wireless download, SecureDigital card, etc.

Referring again to FIGS. 1 and 2, device 10 may include a housing 12 and a front side 14 and a back side 16. Device 10 further comprises a display 18 and a user input device 20 (e.g., a keyboard, buttons, touch screen, speech recognition engine, etc.). Display 18 can comprise a touch screen display in order to provide user input to a processor 40 (see FIG. 3) to control functions, such as to select options displayed on display 18, enter text input to device 10, or enter other types of input. Display 18 also provides images (see, e.g., FIG. 4) that are displayed to and may be viewed by users of device 10. User input device 20 can provide similar inputs as those of touch screen display 18. Device 10 can further comprise a stylus 30 to assist the user in making selections on display 18.

Referring now to FIG. 3, device 10 comprises a processing circuit 46 comprising a processor 40. Processor 40 can comprise one or more microprocessors, microcontrollers, and other analog and/or digital circuit components configured to perform the functions described herein. Processor 40 comprises one or more memory chips (e.g., random access memory, read only memory, flash, etc.) configured to store software applications provided during manufacture or subsequent to manufacture by the user or by a distributor of device 10. In some embodiments, processor 40 can comprise a first applications microprocessor configured to run a variety of personal information management applications, such as calendar, contacts, etc., and a second radio processor on a separate chip or as part of a dual-core chip with the application processor. The radio processor is configured to operate telephony functionality. Device 10 can be configured for cellular radio telephone communication as discussed above.

Device 10 comprises a receiver 38 which comprises analog and/or digital electrical components configured to receive and transmit wireless signals via antenna 22 to provide cellular telephone and/or data communications with a fixed wireless access point, such as a cellular telephone tower, in conjunction with a network carrier, such as, Verizon Wireless, Sprint, etc. Device 10 can further comprise circuitry to provide communication over a local area network, such as Ethernet or according to an IEEE 802.11x standard or a personal area network, such as a Bluetooth or infrared communication technology.

Device 10 further comprises a microphone 36 configured to receive audio signals, such as voice signals, from a user or other person in the vicinity of device 10, typically by way of spoken words. Alternatively or in addition, processor 40 can further be configured to provide video conferencing capabilities by displaying on display 18 video from a remote participant to a video conference, by providing a video camera on device 10 for providing images to the remote participant, by providing text messaging, two-way audio streaming in full- and/or half-duplex mode, etc.

Device 10 further comprises a location determining application, shown in FIG. 3 as GPS application 44. GPS application 44 can communicate with and provide the location of device 10 at any given time. Device 10 may employ one or more location determination techniques as discussed above.

While the detailed drawings, specific examples and particular formulations given describe exemplary embodiments, they serve the purpose of illustration only. The hardware and software configurations shown and described may differ depending on the chosen performance characteristics and physical characteristics of the computing devices. The systems shown and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

A number of references have been made to transmitters, receivers, and/or transceivers. Each reference to a transmitter or receiver is equally applicable to a transceiver. Reference in the claim to a transmitter or receiver is also a reference to a transceiver unless it is explicitly stated that the claim is referencing an independent transmitter or receiver. Reference to functions achieved by a transceiver above could also be accomplished by combining an independent transmitter and receiver. Reference in the claims to a transceiver can also be a reference to a transmitter-receiver combination unless reference is made in the claim to a unitary transceiver.

While described with regards to a hand-held device, many embodiments are usable with portable devices which are not handheld and/or with non-portable devices/systems.

The various single applications discussed above may be performed by multiple applications where more than one application performs all of the functions discussed for the application or where one application only performs some of the functions discussed for the application. For example, the image application 712 may be divided into an image capturing application and a separate image viewing application. Also, more than one application may be included on device 510 that is capable of displaying images as described for image application 712.

Further, while shown as separate applications above, many of the above listed applications can be combined into single applications that perform all or some of the functions listed for more than one of the applications discussed above.

While some components in FIG. 23 were discussed as being singular and others were discussed as being plural, the invention is not limited to devices having these same numbers of each type of component. Embodiments are conceived where each combination of plural and singular components exist.

In some embodiments, the various components shown in FIG. 23 may be combined in a single component. For example, in some embodiments, removable memory 538 may also be an external device connector 540 (such as an SDIO card slot which can be used to receive memory cards, input and/or output data, and combined devices having both memory and input/output functions). As another example, in some embodiments, a single connector could serve as both an external device connector 540 and as a connection to an external power supply 554.

Also, in some embodiments, the function of various claim components shown in FIG. 23 may be performed by a combination of distinct electrical components. For instance, a location circuit 524 may have a separate microprocessor that works in combination with the main microprocessor 526 of the system to perform the functions of the processing circuit 532. As another example, image processing circuit 516 may make use of the electronics of camera 512 to perform image processing, while also having other, discrete electronic components.

1. An electronic device, comprising a user input device and a processing circuit configured to run a location based search application and a contact application, the processing circuit configured to perform a location based search in response to a user input, the search configured to return search results, the processing circuit configured to save information from at least one of the search results as a contact in the contact application.

2. The device of claim 1, wherein the processing circuit is further configured to place a phone call based on information in the saved contact.

3. The device of claim 1, wherein the location based search comprises receiving a user input requesting a search, receiving a user input of search criteria, and retrieving search results from a location information database based on the user input of search criteria.

4. The device of claim 3, wherein at least a portion of the location information database is remote from the electronic device.

5. The device of claim 3, wherein the electronic device is a portable device, and the processing circuit is configured to provide a user a search criteria option to search based on the current location of the portable device.

6. The device of claim 3, wherein
the search results are configured to be displayed to a user on a display of the electronic device,
the processing circuit is configured to receive a user input of a selection of at least one of the search results, and
the processing circuit is configured to provide a menu options selectable by a user, the menu of options including an option to save the at least one search result as the contact in the contacts application.

7. The device of claim 3, wherein the search criteria are received in a top-level screen of the electronic device.

8. The device of claim 3, further comprising retrieving the search results from the location information database based on a current location of the electronic device, the current location configured to be determined based on information from a location circuit of the electronic device.

9. The device of claim 1, wherein the processing circuit is configured to use information from the saved contact in a non-location application.

10. The device of claim 1, further comprising,
an audio circuit configured to facilitate voice communication over a network;
a cellular transceiver coupled to the processing circuit, the cellular transceiver configured to transfer voice information between the audio circuit and a cellular network and to transfer data information between the processing circuit and a cellular network;
a display configured to display information including the results of the location-based search; and
a housing configured to house the cellular transceiver, the audio circuit, the display, the processing circuit, and the user input device, the housing having a volume of less than 2550 cubic centimeters.

11. The device of claim 10, wherein the housing has a volume of up to 540 cubic centimeters.

12. The device of claim 1, further comprising updating information saved in the contact based on an update of information in a location information database used to conduct the location based search.

13. A method, comprising:
performing a location based search configured to provide search results using a location application, the location-based search initiated on a portable hand-held device;
saving information from at least one of the search results on the portable hand-held device without requiring a user to input the information manually; and
accessing saved information from the at least one of the search results using a non-location application.

14. The method of claim 13, wherein accessing the information from the at least one of the search results using a non-location application comprises accessing an e-mail address saved for the at least one of the search results using an e-mail application of the processing circuit.

15. The method of claim 13, wherein accessing the information from the at least one of the search results using a non-location application comprises accessing a phone number saved for the at least one of the search results using a phone application of the processing circuit.

16. The method of claim 13, further comprising accessing the information from the at least one of the search results using a location application.

17. The method of claim 13, wherein saving information from at least one of the search results comprises saving contact and non-contact information for the at least one of the search results.

19. The method of claim 13, wherein saving information from at least one of the search results comprises saving the information in an application run by the processing circuit, the method further comprising synchronizing the information saved in the application run by the processing circuit with a contacts application run by a system remote from the electronic device.

20. The method of claim 13, wherein saving information from at least one of the search results comprises saving the information in a contacts application of the hand-held device.

21. A method performed by a portable electronic device, comprising:
conducting a search configured to provide search results, the search initiated on the portable hand-held electronic device; and
automatically creating a contact and populating fields of the contact in a contacts application of the portable hand-held electronic device based on information corresponding to at least one of the search results.

22. The method of claim 21, wherein the fields that are automatically populated comprise contact information fields.

23. The method of claim 21, wherein the fields that are automatically populated comprise at least one non-contact information field.

24. The method of claim 23, wherein the non-contact information field comprises a system information field.

25. The method of claim 21, further comprising accessing information from at least one of the populated fields of the contact using a phone application of the portable device.

26. The method of claim 25, further comprising placing a call from the phone application using a cellular transceiver of the portable electronic device based on the accessed information in response to a user input on a user input device housed by a housing of the portable electronic device.

27. The method of claim 26, further comprising:
saving the contact in a memory contained within the housing of the portable electronic device
displaying information from the contact using a display housed by the housing of the portable electronic device; and
transferring audio information using an audio circuit housed by the housing of the portable electronic device in response to the phone call placed based on the accessed information.

28. The method of claim 21, wherein conducting the search comprises receiving a user input from an input field on a top-level screen of the portable electronic device.

29. The method of claim 21, wherein conducting the search comprises conducting the search based on information from a location circuit of the portable electronic device.

30. The method of claim 21, wherein conducting the search comprises conducting the search using a location information database remote from the portable electronic device 1.

31. The method of claim 30, further comprising accessing the location information database using a cellular transceiver of the portable electronic device.
